(19) United States
(12) Patent Application Publication
(10) Pub. No.: US 2007/0288264 A1
(43) Pub. Date: Dec. 13, 2007

(54) Method and system for peer-to-peer radiology network tool

(75) Inventors: Richard K. J. Brown, Ann Arbor, MI (US); Anthony T. Pavel, Washington, DC (US)

Correspondence Address: ARENT FOX LLP;Suite 400, 1050 Connecticut Avenue, N.W., Washington, DC, 20036-5339, US

(73) Assignee: Image Exchange Partners, LLC

(21) Appl. No.: 11/790,886

(22) Filed: Apr. 27, 2007

Related U.S. Application Data
(60) Provisional application No. 60/796,203, filed on May 1, 2006.

(51) Int. Cl. G06F 19/00

(52) U.S. Cl. 705/2

(57) ABSTRACT

A method and system for image analysis peer review and virtual request for proposal (RFP) for medical related data interpretation related work that includes hosting medical related data such as a medical image, receiving one or more bids from at least one image analyst for performing an analysis of the medical image, consulting a peer review of the at least one image analyst, and selecting an image analyst on the basis of the one or more bids and the peer review.

This application claims priority from U.S. Provisional Patent Application No. 60/796,203 entitled “Method and System for Peer-to-Peer Radiology Network Tool,” filed May 1, 2006. This application is incorporated by reference herein in its entirety.

### BACKGROUND OF THE INVENTION

1. Field of the Invention

The present invention relates to providing quality image analysis of radiological and other imaging interpretation, including in particular, for example, digitalized images of pathologic specimens both gross and microscopic.

2. Background of the Technology

There is an unmet need in the prior art to provide increased quality in the area of radiological, pathological and other imaging interpretation. This is particularly true for cases requiring consultations or second opinions. There is a need for efficient image exchange among individual physicians, researchers and healthcare institutions. Further, patients are generally ill informed with respect to who is interpreting such images. To address some of these needs, there is an additional unmet need for image exchange partnerships in the image technology space and beyond.

### SUMMARY OF THE INVENTION

The present invention meets at least some of the above needs, as well as others, by providing a method and system for making diagnostic medical images available for distribution. The features of the present invention incorporate elements that allow users to restrict access, and protect patient identity and privacy.

To accomplish these features, one embodiment of the present invention includes at least one server node and multiple peer nodes coupled to a publicly accessible network (e.g., the Internet) or a private network. Features of this embodiment enable participants to become part of a virtual marketplace for the distribution of medical images and other information and services. Additional features include access limitations based on defined parameters of both the image supplier and receiver. Embodiments of the present invention also incorporate continuous quality improvement functions that enable users to grade the quality of the interaction in the marketplace. These features allow users to determine which image exchange partners with which to interact, based on previous performance, for example.

In some embodiments, the data collected from the quality evaluations can then be used by participants to determine which members of the marketplace with whom to interact regarding image interchange. Tags or other identifiers are optionally used to identify relevant information about the images being stored, as well as the quality record of the image supplier or recipient. Both the supplier and recipient are able to control access via a defined set of criteria, based on a pre-set standard or self created data set, for example.

The present invention is thus flexible and allows users to set there own criteria. Among other things, embodiments of the present invention also allow users to exchange services based on volunteer, payment, or barter point based features. The present invention also allows hospitals, physicians or other utilizers of images to exchange images for consultative, peer review, research or image storage services with regard to patient records.

Furthermore, methods and systems of embodiments of the present invention include features for collecting and providing peer review of the image analysis performed by third parties or within a same entity such as, for example, a medical practice group. For example, the peer review can be performed using a search tool that randomly, or with pre-set instructions, selects images and corresponding analyses, and that rates the quality of each analysis. Thus, various search criteria may be included in the search tool in order to perform a customized review of the image analyses that have been performed, as well as other features.

According to various example embodiments, the search tool may also include methods and features for determining, on the basis of image analyses that have already been rated, whether further image analyses should be selected from the database and rated. Accordingly, quality control of the image analyses can thus be accomplished.

According to various example embodiments, a bidding system and method may also be implemented, wherein the various images to be analyzed are, for example, posted on a server that is accessible both by users and image analysts, so that the analysts may submit a bid, which is the price at which the analysts are offering to provide the image analysis to the user, via the same server, for example. Also, the server may hold a forum that allows both users and image analysts to communicate and discuss various issues related to, for example, the image analyses or the bids.

Additional advantages and novel features of the invention will be set forth in part in the description that follows, and in part will become more apparent to those skilled in the art upon examination of the following or upon learning by practice of the invention.

### BRIEF DESCRIPTION OF THE FIGURES

In the drawings:

FIG. 1 shows various features of an example computer system for use in conjunction with an embodiment of the present invention;

FIG. 2 presents an exemplary system diagram of various hardware components and other features, in accordance with an embodiment of the present invention;

FIG. 3 contains another exemplary system diagram of various components usable with embodiments of the present invention, as well as the representative functionality indicated;

FIG. 4 shows an exemplary flow diagram of various methods performed in accordance with an embodiment of the present invention;

FIG. 5 is a flow diagram illustrating an example embodiment of a method according to this invention;

FIG. 6 is a flow diagram illustrating an example embodiment of a method according to this invention;

FIG. 7 is a flow diagram illustrating an example embodiment of a method according to this invention; and

FIGS. 8-56 contain exemplary graphical user interface (GUI) screens for logging into and performing sample operations in an exemplary software system, in accordance with an embodiment of the present invention.

### DETAILED DESCRIPTION

Among other things, the present invention provides a system and method for making diagnostic medical images available for distribution. The features of the present invention incorporate elements that allow users to restrict access and protect patient identity and privacy.

Embodiments of the present invention provide both the software by which users may connect to the system and data storage capability, both for those sites lacking storage and for those having storage but needing off-site centralized services to facilitate data transfer and longitudinal storage. Additionally, features allow patients, hospitals, physicians or other users of images, which may seek many providers or imagers, for example, to store images longitudinally at a centralized site, and to visit only sites that are certified or otherwise subject to the present invention. These features allow user and patient confidence to be built and partnered sites to be promoted for use. This feature is thus attractive on multiple levels—professional users and patients are able to view their own images and reports, and to obtain other services, such as second opinions of member centers (e.g., via a fee for service).

In embodiments of the present invention, longitudinal activity is stored, such that, if the patient was seen locally and sent to a specialty hospital, for example, any stored data may be transferred, assuming the patient were also a member user of the present invention (e.g., upon payment of a fee to be a member). Additionally, the present invention encourages intra-organizational use, as well as use within a global marketplace. For example, within the U.S. Department of Defense (U.S. DOD), a patient may be cared for in multiple facilities.

If all such facilities use the present invention, then from anywhere the patient or other user accesses information, immediate access to all images diagnostic patient data and information which can be processed into diagnostic images and reports would potentially be available. Additionally, when the patient leaves the service, the patient and family members are able to be cared for by continued access capability (e.g., using the longitudinal code to access this information). Further, if the patient or any participating family member ever becomes ill, other member hospitals or imaging centers are able to participate, so as to be able to obtain the images.

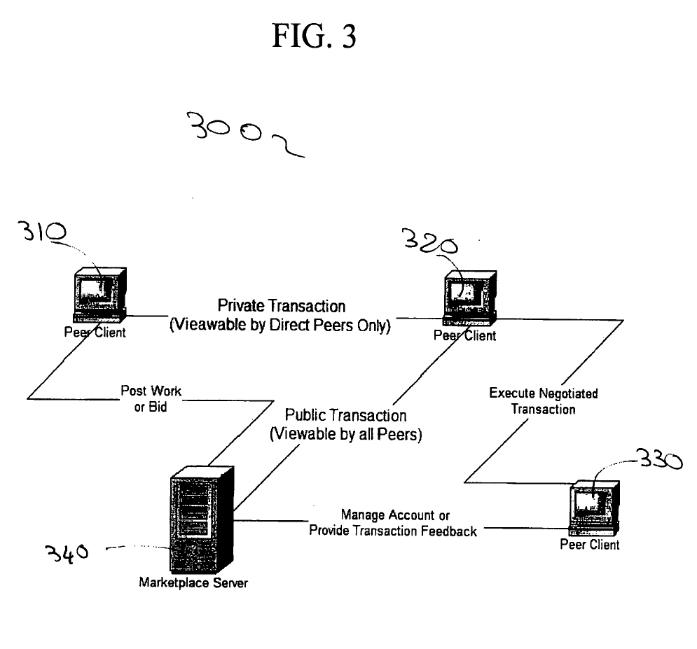

One illustrative embodiment of the present invention, referred to interchangeably herein as the Peer-to-Peer Radiology Network Tool (PTPRNT), provides a method and system for making diagnostic medical images available for distribution. The features of the tool incorporate elements that allow users to restrict access, maintain patient identity, and protect privacy. In one variation, the method and system include at least one server node and multiple peer nodes connected to a publicly accessible or private network (see, e.g., FIG. 3 below).

The PTPRNT enables participants to become part of a virtual marketplace for the distribution of medical images. The features of this tool include access based on the defined parameters of both the image supplier and receiver. This embodiment also incorporates a continuous quality improvement function, which enables the users of the marketplace to grade the quality of the interaction in the marketplace. The data collected from the quality evaluations can then be used by participants in the PTPRNT to determine which members of the marketplace with whom to interact regarding image interchange. Tags are used to identify relevant information about the images being stored and the quality record of the image supplier or recipient.

Both the supplier and recipient are able to control access via a defined set of criteria, based on a pre-set standard or self-created data set. The system is flexible and allows users to set their own criteria. The PTPRNT also allows the participants to exchange services based on a volunteer, payment, or barter point based system.

Elements of PTPRNT in accordance with one embodiment of the present invention include the following:

a) Secure Access
Access is private and appropriate over properly secured infrastructure.
Access is maintained at a global, as well as transactional level.

b) Patient Confidentiality
Patient Confidentiality is maintained to all appropriate levels on a transaction basis, for example, ranging from completely blind to fully disclosed, as determined by the relationships among the submitting and interpreting entities.

c) Transaction Definitions
Each transaction is governed by definitions that are mutually defined and agreed upon among the submitting and interpreting entities. These include, but are not limited to:
   Access
   Affiliation
   Study type
   Read type
   Location
   Qualification
   Urgency

d) Quality Rankings
Participating entities are able to have quality rankings based on participant and system defined feedback, which can be used as market differentiators and contribute in the selection process. These ranking factors include, but are not limited to:
   Time to interpretation
   Report Quality
   Image Quality

e) Participant Registration
Appropriate participant information is registered to be used as market differentiators and contribute to the selection process. These differentiators include, but are not limited to:
   Specialty
   Modality
   Location
   Credentialling

f) Qualification Guarantees
Appropriate participant qualifications are registered to be used as market differentiators and contribute to the selection process. Adherence to applicable compliance regulations are maintained.

g) System Monitoring
Transactions are monitored based on general and user defined parameters. Appropriate notifications and alerts are made by the system when triggered, such as completed and/or overdue interpretations.

h) Transaction Bidding
Bidding is credit based, where credit values can be in both monetary and barter based systems. Cases can be put out to open bidding, allowing submitting and interpreting entities to compete, or can be predefined along the lines of strict one-to-one relationships between the submitting and interpreting entity, or can be managed, for example, by insurance companies, HMOs, regional health organization, group purchase plans, and the like, to contract for image interpretation and peer review for their physician and/or patient base. This may also function as a virtual Request for Proposal (RFP) in this situation.

i) User Defined Parameters
In addition to system standard parameters, participating entities can define individual attributes at a general and transactional level. These attributes can be used as market differentiators and contribute in the selection process.

An exemplary control panel on the submitting side, in accordance with an embodiment of the present invention, includes the following capabilities:
a) Can either reveal or hide patient specific identifiers.
b) Can select whether the content can be viewed by internal network or across all observers in the system.
c) Tags identifying the type of case can be pulled off of both the Dicom (or similar non-Dicom standard) data, as well as controlled by the submitting party. Tags are structured, for example, in both pull down menu or other selectable format, with option to create new fields.
d) Tags can be used in identifying the type of interpretation desired (e.g., consult, formal reading, peer review type reading).
e) Geocoding/Entity coding can be used so that submitters can request that cases be read by interpreters in specific locales (e.g., state, country, corporation, group).
f) Blocking option can be selected to preclude certain readers from eligibility to view the case.
g) Preference options can be selected that can be used by submitter to request certain entities review the case.
h) Commerce options can be selected that allow prepay for services based on either an actual or barter type method. Also, the end user can either put the case up for review or put it in a bid queue. Bid queue cases may be set at a lower interpretation rate, based on the preference of the submitter. Reviewers can select either to view these cases or to ignore all but the standard pay studies. Bids may optionally be stratified by value. (This component has implications for using a peer-to-peer system for all kinds of e-commerce, for example, except that the payment may occur in the reverse direction relative to a buyer-seller model).
i) Grading system features can be selected that allow submitters to evaluate the value of the interpretation. This information then becomes appended to the interpreter's personal record in the system for others to review.
j) Grading system features can be selected that allow reviewers to evaluate the quality of the images and information. This information then becomes appended to the submitter's personal record in the system for others to review.
k) All items (cases) may be given a time code by the central system, in order to make it possible to sort order studies (items) by the amount of time they have been available in the system. In some variations, the user is able to request notification if a case is not interpreted by a set time interval.
l) Once a case is selected by a reviewer, optionally, access to other reviewers may be blocked, unless otherwise selected by the submitter.
m) The control panel or other selection mechanism allows the user to obtain the identifier of the interpreter, as well as the time the case was accessed, the time to final review, and the reviewer's grade history on other cases.
n) Submitters are able to select the acuity of the case. In other words STAT, ASAP, standard read, etc.
o) The Control Panel or other selection mechanism includes a function for monitoring status of all cases the submitter had placed in the system.
p) Interpretations are flaggable by acuity codes, as well (e.g., needs to be read immediately, abnormal but not emergent findings on images).
q) E-mail notification options are provided that enable reporting of results either in encoded mode without patient ID or with patient ID (e.g., only could be sent over secure network if patient IDs not encoded).

Example embodiments will now be described in conjunction with the following figures.

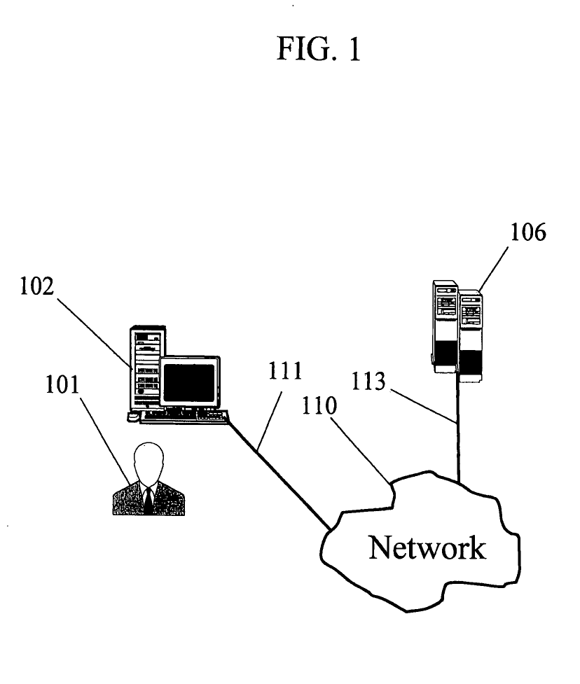

FIG. 1 shows various features of an example computer system 100 for use in conjunction with an embodiment of the present invention. As shown in FIG. 1, the computer system 100 is used by a patient, a provider, or other user 101 to access data, such as images, or services from a server or other network device 106 via a terminal 102, network (e.g., the Internet) 110, and couplings 111, 113. The terminal 102 may comprise, for example, a personal computer (PC), minicomputer, mainframe computer, microcomputer, telephone device, personal digital assistant (PDA), or other device having a processor and input capability. The server 106 may comprise, for example, a PC, minicomputer, mainframe computer, microcomputer, or other device having a processor and a repository for data or that is capable of accessing a repository of data. Couplings 111, 112 may include wired, wireless, or fiberoptic links.

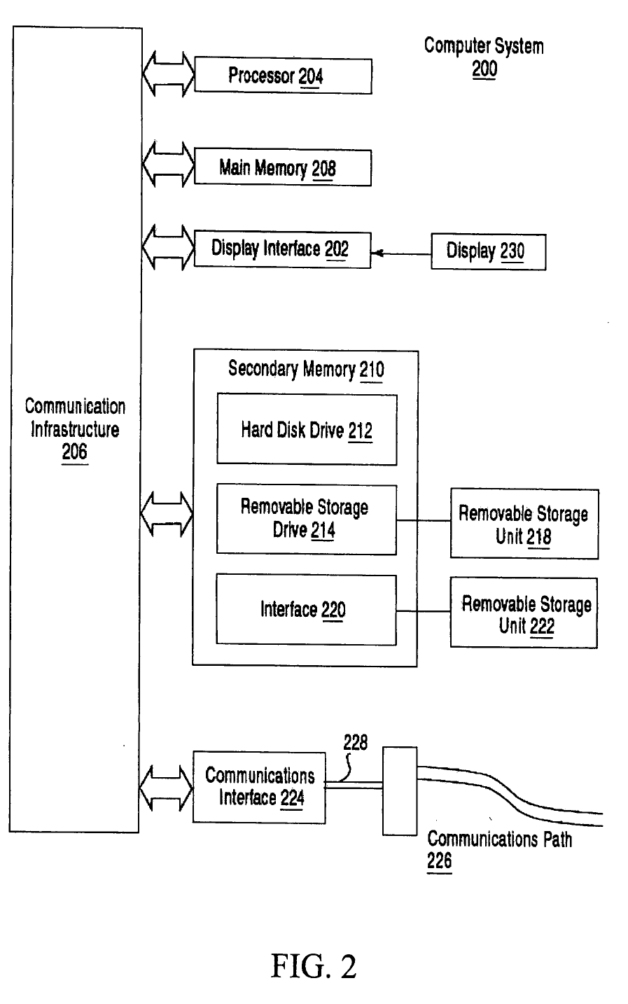

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 200 is shown in FIG. 2.

Computer system 200 includes one or more processors, such as processor 204. The processor 204 is connected to a communication infrastructure 206 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 200 can include a display interface 202 that forwards graphics, text, and other data from the communication infrastructure 206 (or from a frame buffer not shown) for display on the display unit 230. Computer system 200 also includes a main memory 208, preferably random access memory (RAM), and may also include a secondary memory 210. The secondary memory 210 may include, for example, a hard disk drive 212 and/or a removable storage drive 214, representing a floppy disk drive, a magnetic tape drive, an optical disk drive, etc. The removable storage drive 214 reads from and/or writes to a removable storage unit 218 in a well-known manner. Removable storage unit 218, represents a floppy disk, magnetic tape, optical disk, etc., which is read by and written to removable storage drive 214. As will be appreciated, the removable storage unit 218 includes a computer usable storage medium having stored therein computer software and/or data.

In alternative embodiments, secondary memory 210 may include other similar devices for allowing computer programs or other instructions to be loaded into computer system 200. Such devices may include, for example, a removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other removable storage units 222 and interfaces 220, which allow software and data to be transferred from the removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 228, which may be electronic, electromagnetic, optical or other signals capable of being received by communications interface 224. These signals 228 are provided to communications interface 224 via a communications path (e.g., channel) 226. This path 226 carries signals 228 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 214, a hard disk installed in hard disk drive 212, and signals 228. These computer program products provide software to the computer system 200. The invention is directed to such computer program products.

Computer programs (also referred to as computer control logic) are stored in main memory 208 and/or secondary memory 210. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an embodiment where the invention is implemented using software, the software may be stored in a computer program product and loaded into computer system 200 using removable storage drive 214, hard drive 212, or communications interface 224. The control logic (software), when executed by the processor 204, causes the processor 204 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

FIG. 3 contains another exemplary representative system diagram of various components usable with embodiments of the present invention, as well as the representative functionality indicated. In FIG. 3, the system 300 includes a plurality of peer terminals 310-330 and a server 340. According to various example embodiments, the various peer client terminals 310-330 may be coupled among themselves, only or coupled to the server 340. For example, peer client terminal 310 may have one or more images to be analyzed, and peer client terminals 320 and 330 may be two different image analysts' terminals. Thus, the peer terminal 310 may signal that there is a need for the analysis of the one or more images via the server 340, and because peer image analysts' terminals 320 and 330 also have access to the server 340, the peer image analysts terminals can bid for performing the analysis by posting a bidding price for their services via the server 340. According to various example embodiments, once the peer image analysts' terminals 320 and 330 post their bids via the server 340, the peer user 310 may select the best bidder, and continue dealing with the best bidder either via the server 340 or directly with the best bidder 320 or 330. The selection process for the best bidder may include not only the bidding price of the bidder, but also a variety of other parameters such as the quality of the bidder, past experience of the bidder, and the like.

According to various example embodiments, each peer client terminal 310-330 may store and maintain account information, private and secure data, peer work history, peer bid history, peer transaction history, peer feedback and rating history, and the like. Also, the server 340 may store and maintain the peers' public account information, the posted work history, the posted bid history, the transaction history, and the feedback and rating history of some or all the peers linked to the server 340.

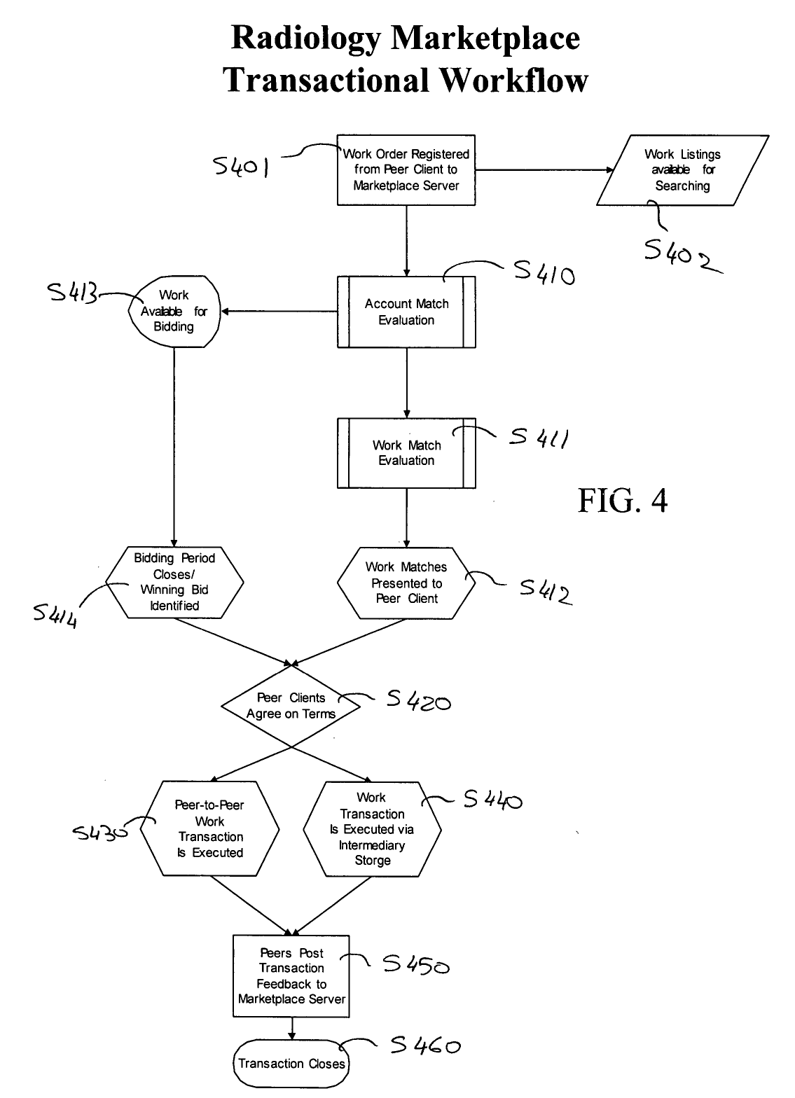

FIG. 4 shows an exemplary flow diagram of various transactions performable in accordance with an embodiment of the present invention. In FIG. 4, the method starts in step S401, the Work Order Registered from Peer Client to Marketplace Server step, where a registered user submits a work item into the marketplace. This function may be achieved by submitting information in a standardized way to the marketplace server, detailing the type of work and the terms under which the work is to be performed. Examples may include an imaging center submitting cases to be read or a radiology entity submitting availability to read cases. Then, the method continues to step S402, the Work Listings available for Searching step, where one of the capabilities of the marketplace is the ability to search both open work cases and work history. In this way, registered users are able to see what the activity of the marketplace has been, as well as to determine information on participants vis-à-vis their work history and feedback. Next, the method continues to step S410.

In step S410, the Account Match Evaluation step occurs, which, because all marketplace participants are registered, and due to the legalities and complexities entailed with the delivery of healthcare, one of the services provided by the marketplace is to pre-screen work for appropriateness. This function filters work so that a given work order is only available to appropriate accounts for either bidding or automated matching. Next, control continues to step S411, the Work Match Evaluation step, in which, with well structured account and work item information, the marketplace is able to automatically match work pairs. This could be set up via pre-defined criteria (Radiology group A will read all work from Imaging Center B for the year) or via best fit matching (Radiology group A has a work order registered to read MRIs in Michigan, Imaging Center B located in Michigan needs MRIs read for a month). In this way, the system is able to provide a value added service by connecting appropriate entities, groups or individuals. Next, control continues to step S412.

In step S412, the Work Matches presented to Peer Client step, automated matches via the Marketplace are presented to the registered account as potential partners for the particular work item. The user would then have the ability to accept or reject these matches. Alternatively, once the work has been filtered to render a given work order only available to appropriate accounts for either bidding or automated matching during step S410, the method continues to step S413, the Work Available for Bid 413 step, where work is made available for bidding to appropriate users in an open market system. The marketplace software manages the bidding, in terms of who can bid, and ensures that all bidding falls within the defined parameters of the work item. Next, the method continues to step S414, the Bidding Period Closes/Winning Bid Identified step, where, once bidding on a work item closes, a winning bidder is identified within the marketplace. The winning bidder is then presented, along with any automated matches to the user who submitted the work item. Next, the method continues to step S420, the Peer Clients Agree on Terms step, where the user that registered the work order may select a partner to execute the work order. This partner could be the winning bidder or a partner resulting from an automated match. Next, the method continues to step S430.

In step S430, the Peer-to-Peer Work Transaction is Executed step, once the work order is agreed upon, the work can be executed in a Peer-to-peer fashion directly between the Marketplace users, external to the marketplace server. As members of the marketplace, software is available that enables the parties to execute the work directly among themselves in a secure and private manner. The work item may be tracked within the marketplace, but all details of the work may be managed among the peers. Alternatively, once a partner is selected to execute the work order during step S420, the method continues to step S440, the Work transaction is Executed via Intermediary Storage step, where one option for executing work orders is to use intermediary servers to facilitate the execution of a work order. All privacy and security is maintained, and the details of the transactions remain separate from the general marketplace data. The intermediary storage is a value added service to help facilitate the work, but its use may be optional, for example. The concept in general would be that Imaging Centers could send studies to the Intermediary Storage System and radiology groups could pick the studies up from the same system. Likewise, this Intermediary Storage could be used to deliver results back via a similar pathway. Next, the method continues to step S450.

In step S450, the Peers Post Transaction Feedback to the Marketplace Server step occurs, where, as part of transaction closure, the participants in any work item provide feedback on the execution of the work. This step may include, but not be limited to, qualitative data on the other participant, as well as information about the execution of the specific transaction itself. This feedback may in turn be used to further qualify users for future transactions. Finally, the method continues to step S460, where the transaction closes and the method ends. A given work item may be considered closed once all the terms of the work item have been met and the appropriate feedback has been registered within the marketplace. This information would then be part of the marketplace work record and available for searching, as well as be available to serve as input in future accounts and work matches.

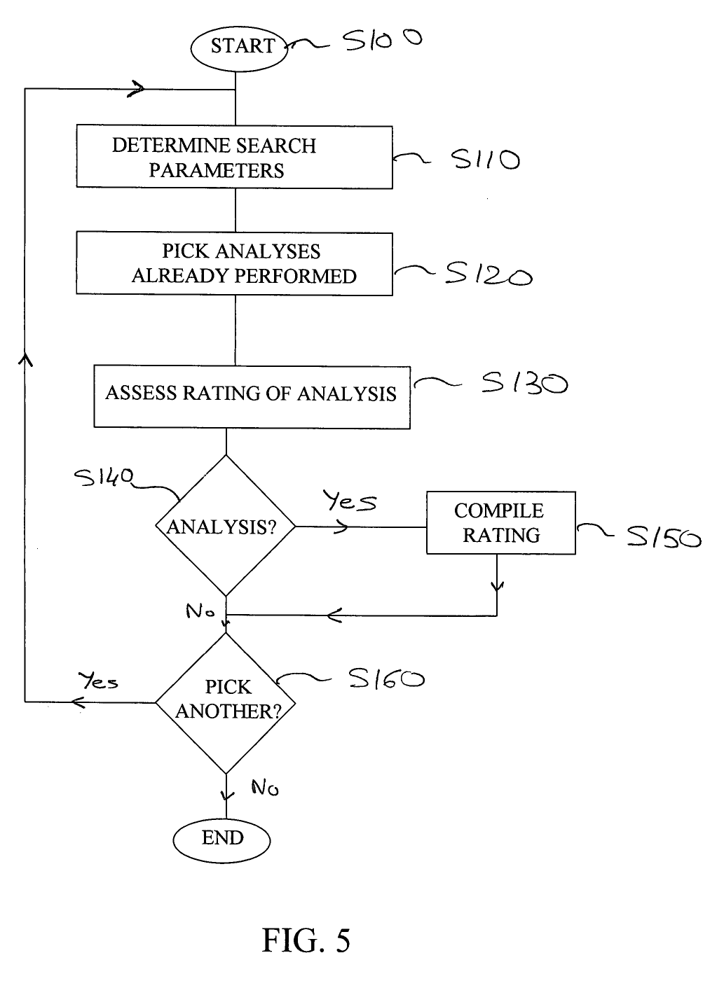

Furthermore, the methods and systems of this invention provide a method and system to collect and provide peer review of the image analyses performed by third parties. For example, the peer review can be performed using a search tool that randomly selects images and their analyses, and that rates the quality of the analyses. FIG. 5 is a flow diagram illustrating an example embodiment of this method. In FIG. 5, the method starts in step S100, and continues to step S110, were the parameters for a search among some or all of the image analyses are determined. According to example embodiments, various search criteria may be included in the search tool, in order to perform a customized review of the image analyses that have been performed. It should be noted that, although medical images are indicated here, the same method can be used on any medical related data such as, electrocardiograms (EKG), electro-encephalograms, that do not necessarily hold an image. In other words, the term “data” encompasses any patient data, including digitized images and raw data that can be utilized directly or processed into a format that can be used for diagnostic or peer review purposes. Similarly, any diagnosis data set, that may or may not include images, but also graphs, charts, and other data that help in the diagnosis of a patient, may also be used in this method and in all other methods disclosed herein. In fact, the terms “image” can readily be changed to “medical related data” or “diagnosis data set” in all aspects of this invention.

It should be noted that, for example, the parameters may either be in a word format or in the form of codes. Also, for example, the various search criteria may include the name of the image analyst, the date or period of time during which the image analysis was performed, the type of image to be analyzed, the price for which the image analysis was performed, and the like. Various example embodiments may also store all the image analyses in a database, or other data repository, and include a variety of search fields, such as person who performed the image analysis, type of image analysis, name of patient, date of examination, and the like. According to other example embodiments, a control panel or other interface may be set up to enable the user to determine pre-set parameters for the selection of cases to be reviewed, and output a number of cases that need to be reviewed, on the basis of the pre-set parameters. The panel or other interface may also determine what level of performance, or quality rating, requires increased scrutiny, and adjust the number of cases that need to be reviewed, on the basis of the pre-set parameters.

Next, the method continues to step S120, where, once the search parameters are determined, one or more image analyses are selected for a quality assessment. According to various example embodiments, the search tool can select analyses that have been performed by a specific individual, or images of a specific nature, such as MRI or CAT-Scan, or the like, as dictated by the search parameters determined in step S110. The search tool is also able to be instructed only to select a certain number of image analyses, or a specific percentage of the image analyses performed by, for example, a given analyst, or the like. According to various example embodiments, the search may be based in word form or in code, when the parameters are coded.

According to various example embodiments, an Interactive Annotation may be used, where a graphic or symbolic overlay can be embedded in an image that has been or that will be analyzed, and the overlay may be used to indicate a finding on the image. For example, the Interactive Annotation may be stored with or accessible in conjunction with the database in order to facilitate the search for images or to indicate the location of findings on the image. Furthermore, any comments about the image may be incorporated in the overlay and stored, for example, together with the image, in the database. The Annotation may also include additional information for review by other users. Thus, when accessing the image, a user can also access the Annotation that has been stored by, for example, selecting a certain area of the image, right-clicking the mouse, or entering a specific command on the keyboard of a computer. The user may also add additional data or information in the Annotation. It should be noted that the Annotation may include, for example, data, notes, opinions or follow-up questions, and/or links to other content or rich media, such as video clips, or the like.

The Interactive Annotation may also include a list of suggested resources that may be useful to a user. For example, if there are musculoskeletal related erroneous analyses from the image analyst, selecting the overlay of the image spawns a “suggested readings” category that provides a link to any relevant books, products or educational conferences. In addition, the link to a Questions and Answers (Q&A) database may include fields such as the image analyst's response to the peer review (e.g., agree or disagree with explanations), or an action taken if they disagree (e.g., will inform referring doctor of the erroneous analysis, will change report, insignificant finding no action needed). These responses may then be transmitted to the database or other data repository for re-credentialing purposes, for example. This additional tool may enable a reviewer to annotate with an arrow, or other graphic icon or other feature, the focus of the erroneous analysis. This result then becomes part of the image or becomes accessible in the image file. When the image analyst then sees the image with the overlay on it, the image analyst may access the reviewer's comments. If this is also tied to the peer review component of the database, then the reader is able to search for similar categories that may contain erroneous analyses. In addition, for re-credentialing purposes, the supervisor of the image analyst can quickly determine how often the image analyst makes this sort of mistake by merely looking at one case with the icon tied to the database or other data repository.

Next, the method continues to step S130, where the quality of the image analysis of the images picked during step S120 is assessed, and a quality rating is assessed. For example, a quality rating may be a score, on a predetermined scale, indicative of the quality of the image analysis. Furthermore, a tool may be provided to determine the name of the software product used for the image review. This information may also be attached to the overlay as a hyperlink with information about the software. For example, when an MRI is viewed with a proprietary software program, and the image analyst (in this example, a radiologist) renders an interpretation or analysis of the image, the overlay may indicate that the images for the report were viewed with Software X, and also include a link that may allow a reviewer or other user to purchase Software X by clicking on a link. Among other things, this feature would therefore provide an embedded marketing tool for the software used.

Alternatively, the party or individual who performed the analysis of the image originally may have the opportunity to access the web site and post their opinion on the rating of their analysis. For example, the party or individual may indicate whether they agree with the assessment, or whether they disagree. In case they disagree, the individual or party may also post the reasons why they disagree with the quality assessment of the image analysis that they performed. The opinion may also be stored in a database and may be accessible by other parties.

Next, the method continues to step S140, where a determination is made of whether the image analysis was already performed. If an analysis of the image selected during step S120 has been performed previously, then the method continues to step S150, where a combined rating, which includes any ratings previously determined, as well as the current rating, is compiled. Accordingly, the image now has a quality rating that is a combination of all the determined ratings.

If an analysis of the image has not been performed previously, then the method continues to step S160, where a determination is made as to whether to select another image for a quality rating assessment. If a determination is made that another image should be selected for a quality rating assessment, then the method continues to step S110, and new parameters for a search of the image analysis database or other data repository are determined. According to various example embodiments, the new parameters may be similar to or different from the parameters used during the previous quality rating assessment. If a determination is made that another image should not be selected for a quality rating assessment, then the method continues to step S170, where the method ends.

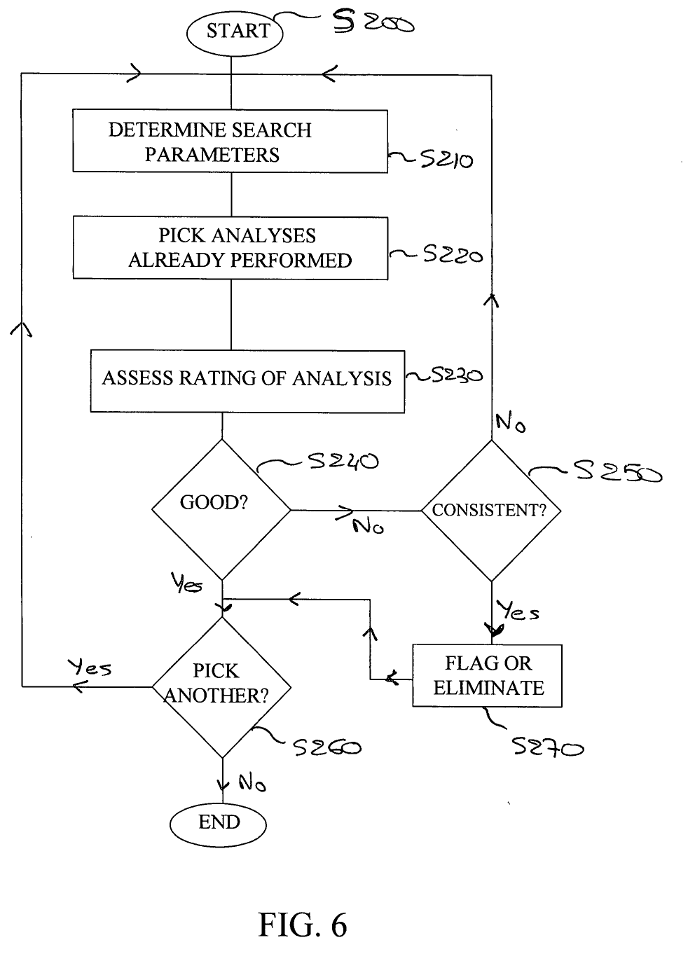

FIG. 6 is a flow diagram illustrating an example embodiment of a method relating to ratings features, according to the present invention. In FIG. 6, steps S200-S230 are similar to steps S100-S130 of FIG. 5, and will not be discussed further. After step S230, the method continues to step S240, where a determination is made as to whether the quality rating assessment is good. For example, if the quality assessment is established in terms of a number on a scale, then a threshold rating can be designated as the minimum rating for which an image analysis can be determined to be good. Thus, if the quality rating of an image selected during step S220 is equal to or greater than the threshold rating, then the image analysis is deemed to be good. Otherwise, the image analysis is deemed not to be good. Thus, if a determination is made as to whether the quality rating assessment of the image analysis is good, the method continues to step S260, where a further determination is made as to whether to select another image analysis for quality assessment. If a determination is made to select another image analysis for quality assessment, then the method continues to step S210; otherwise, the method continues to step S280, where the method ends.

However, if, during step S240, a determination is made that the quality rating assessment of the image analysis is not good, then the method continues to step S250, where a determination is made as to whether the current quality rating assessment is consistent with any quality rating assessments previously made. If the current quality rating assessment is not consistent with prior ratings, or if the current quality rating assessment is the first quality rating assessment performed on the current image analysis selected during step S220, then the method continues to step S210. However, if the current quality rating assessment is consistent with prior ratings, then the method continues to step S270, where the image analyst or analyzing entity is flagged for producing a poor quality assessment. Alternatively or in addition, the image analyst or analyzing entity may be eliminated from the pool of potential image analysts because of consistent poor image analyses.

Thus, the search tool may also include a method or features that determine, on the basis of image analyses that have already been rated, whether further image analyses should be selected from the database or other data repository and rated. For example, if the image analyses that have been performed by a specific image analyst or analyzing entity have consistently received a low rating, then more image analyses may be selected from the database or other data repository that have been performed by the same image analyst or analyzing entity, in order to make a quality assessment of the image analyst. Accordingly, quality control of the image analysis can thus be accomplished, wherein the image analyst or analyzing entity that consistently produces image analyses that are rated low may be, for example, flagged as underperforming, and possibly eliminated from the list of image analysts available in the database or other data repository. Thus, users may be protected from having their images analyzed by underperforming analysts.

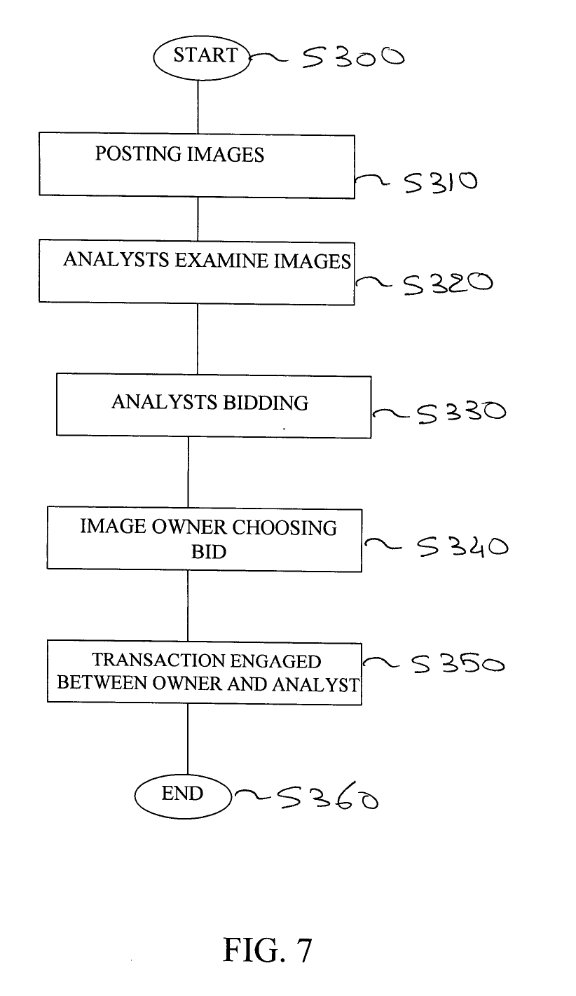

FIG. 7 is a flow diagram illustrating an example embodiment of a method for web posting and bidding and related features, in accordance with operations of various features of the present invention. In FIG. 7, the method starts in step S300, and continues to step S310, where a user posts one or more images that the user wants analyzed on a server. According to various example embodiments, a web site may be set up to receive the postings of the user. It should be noted that the web site may be secured, and made available only to users who gain access to the web site via, for example, payment of a fee, or the like. It should be noted that users can also post a request for the analysis of a group of images, and users can bid on the entire group of analyses, thus taking advantage of economies of scale. Next, the method continues to step S320, where one or more image analysts, who have access to the web site, examine the images posted by the user, and determine the amount of the bid that they may provide to the user via the server. Next, the method continues to step S330, where the bid amount may be posted on the server via the web site. It should be noted that the web site may be secured, and made available only to image analysts who gain access to the web site via, for example, payment of a fee, or the like. Also, the level of access to the data available on the server via the web site may vary among users and among image analysts. Thus, a bidding system and method may also be implemented, wherein the various images to be analyzed are posted on a server that is accessible both by users and image analysts, so that the analysts may submit a bid, which is the price at which they are willing to provide the image analysis to the user, to the same server.

Next, the method continues to step S340, where the user selects the best bid. The user, having access to the server, can review the various bidding prices for the specific image that the user wants analyzed, and select the best bid for an image analyst. According to various example embodiments, users may also have access to the rating of the analysts and weigh the rating of the analysts against the bid provided. For example, if an analyst provides a very low price for an image analysis, but the analyst's rating is low, then the user may prefer to select another analyst, even if the other analyst proposes a higher bid to perform the image analysis. Accordingly, users can obtain various bids from different image analysts, and are able to select bids by taking into account parameters other than merely the price.

Next, the method continues to step S350, where the user and the image analyst engage in a transaction, in which such details as time of delivery and payment method may be discussed or negotiated. According to various example embodiments, once the user selects the best bid, the user has two options as to how to proceed. The user can simply continue dealing with the image analyst via the server, and instruct the image analyst to perform the analysis of the image via the server, and then provide the image analyst with payment separately. Alternatively, the user can separately contact the image analyst directly without using the server, and complete the transaction with the image analyst in a more private manner.

As discussed above, when a bid provided by an image analyst is accepted by a user, the user and the image analyst may either communicate directly or continue to communicate via the server that is able to access the database or other data repository. According to various example embodiments, a boiler plate contract may be made accessible to both users and image analysts, and both parties may execute the contract, binding them for the image analysis, either immediately or after having modified the contract to fit their particular needs. Furthermore, the server may also provide a forum that allows both users and image analysts to communicate and discuss various issues related to, for example, the image analyses or the bids. Next, the method continues to step S360, where the method ends.

It should be noted that a party that posts images may have a preferred image analyst, and may bypass any bidding contest either on the basis of the type of image to be analyzed, or on the basis of the score of an image analyst. For example, the party that posts images to be analyzed may select an MRI specialist if the images to be analyzed are MRI images. Also, a party may select an image analyst on the basis of personal preference or, for example, the reputation of the image analyst. Also, information about the image analysts may be stored in a database and may include, for example, the name of the image analyst, a summary of the experience of the image analyst, and the like.

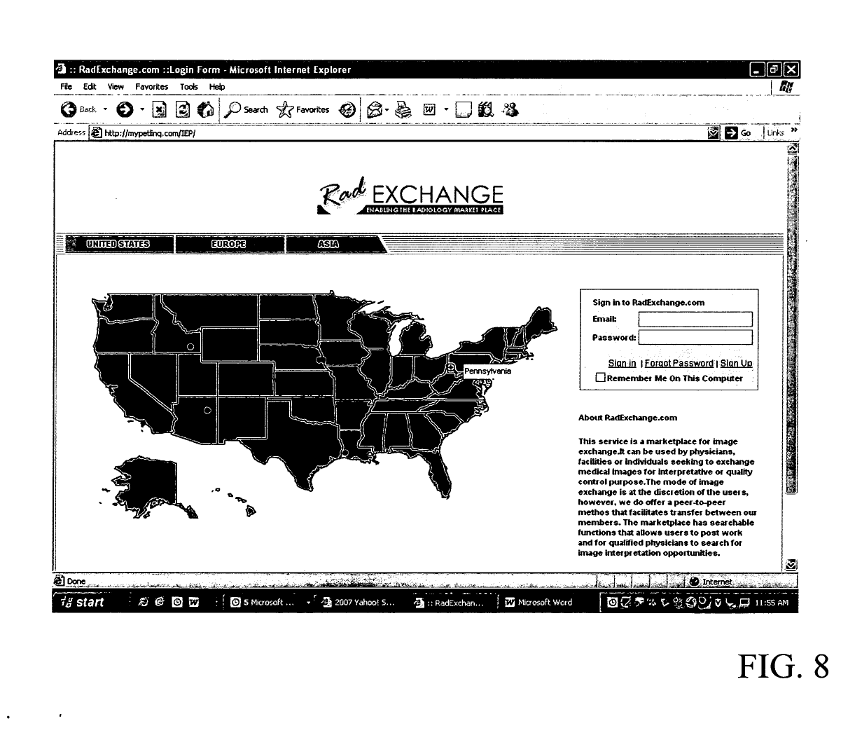

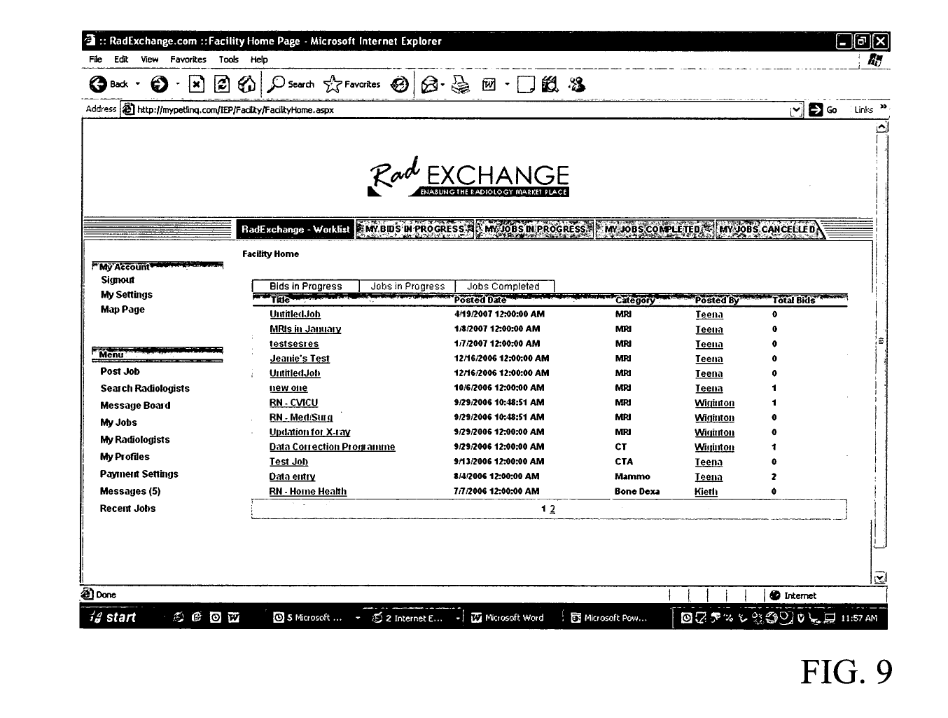

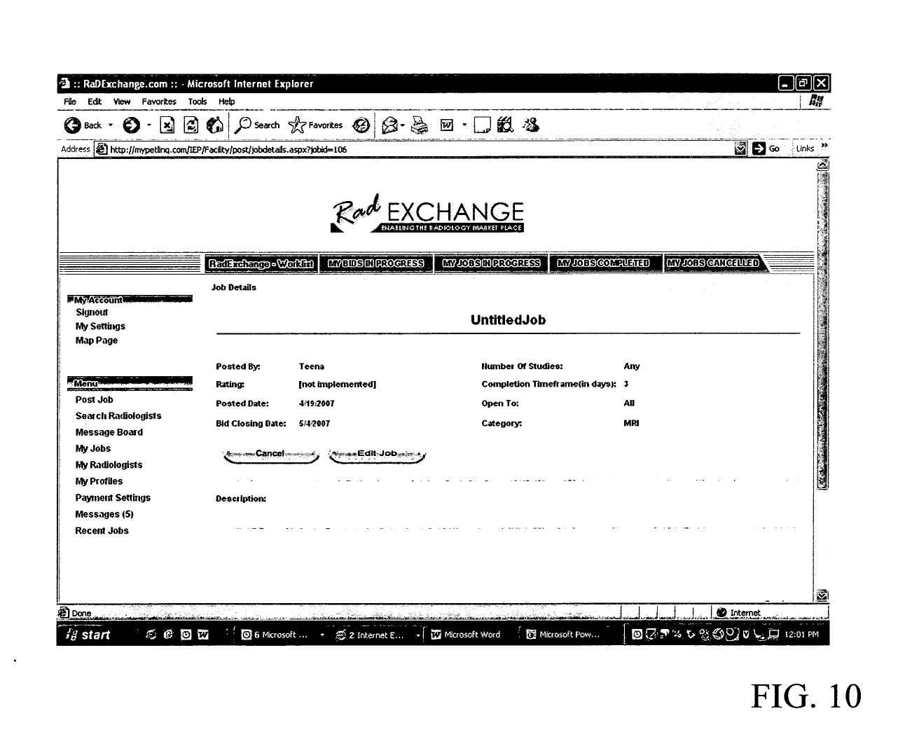

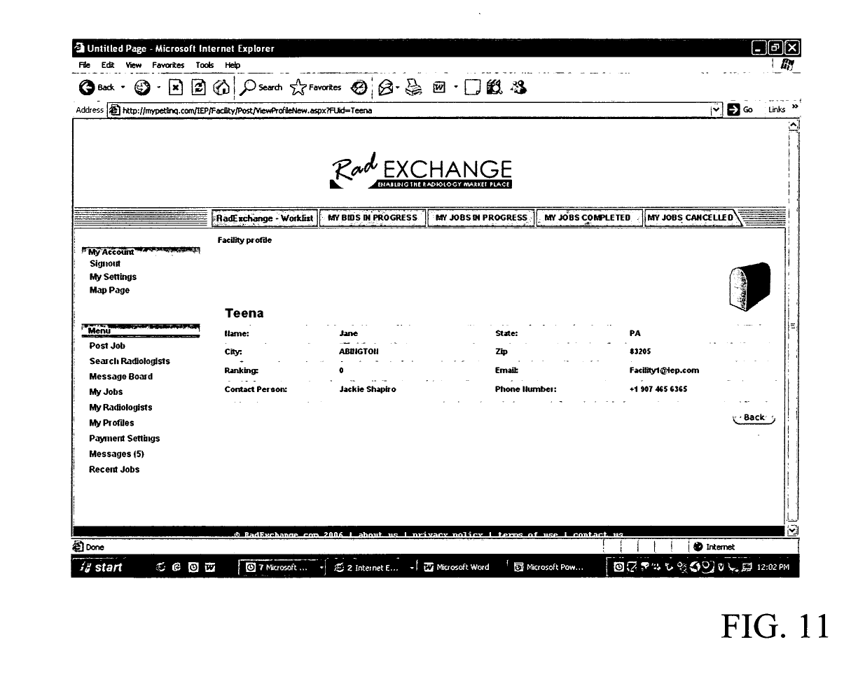

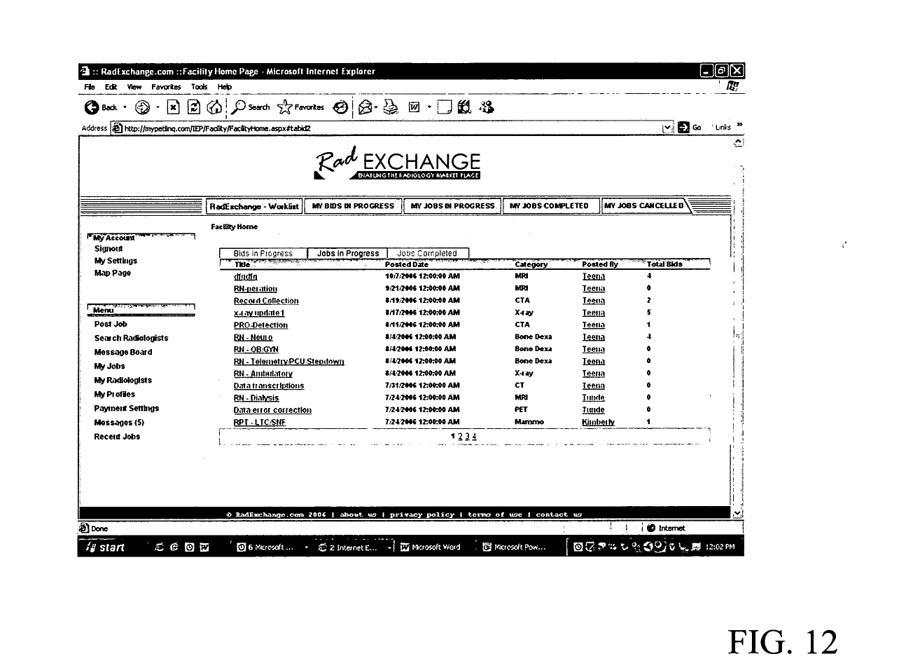

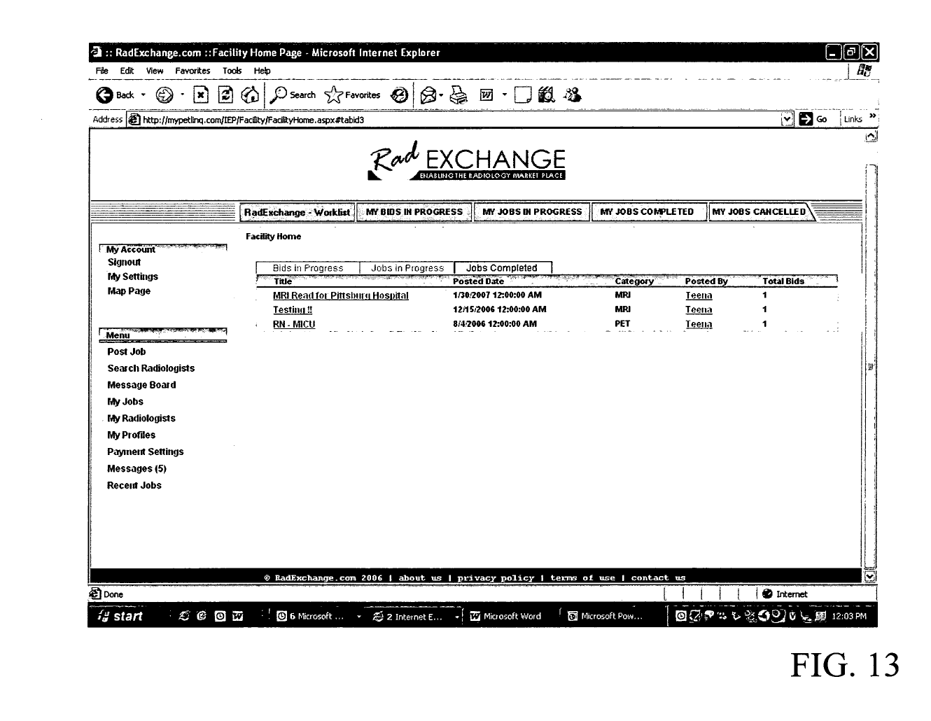

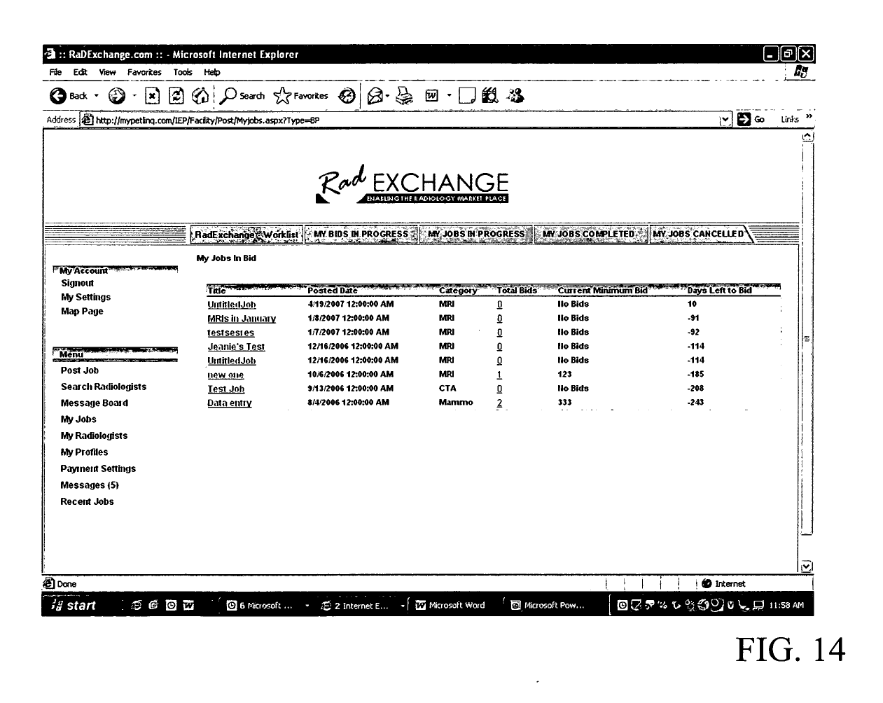

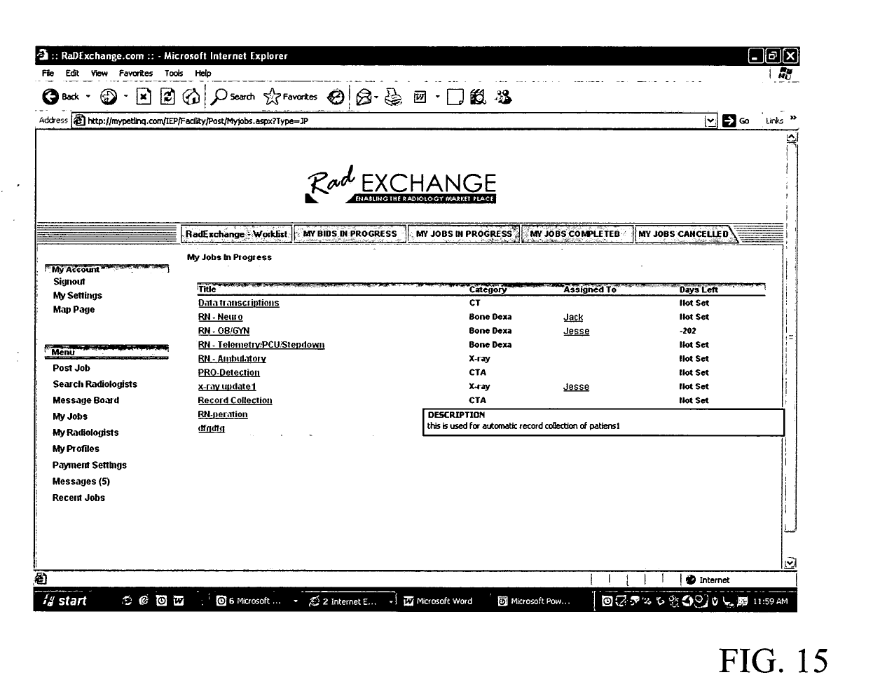

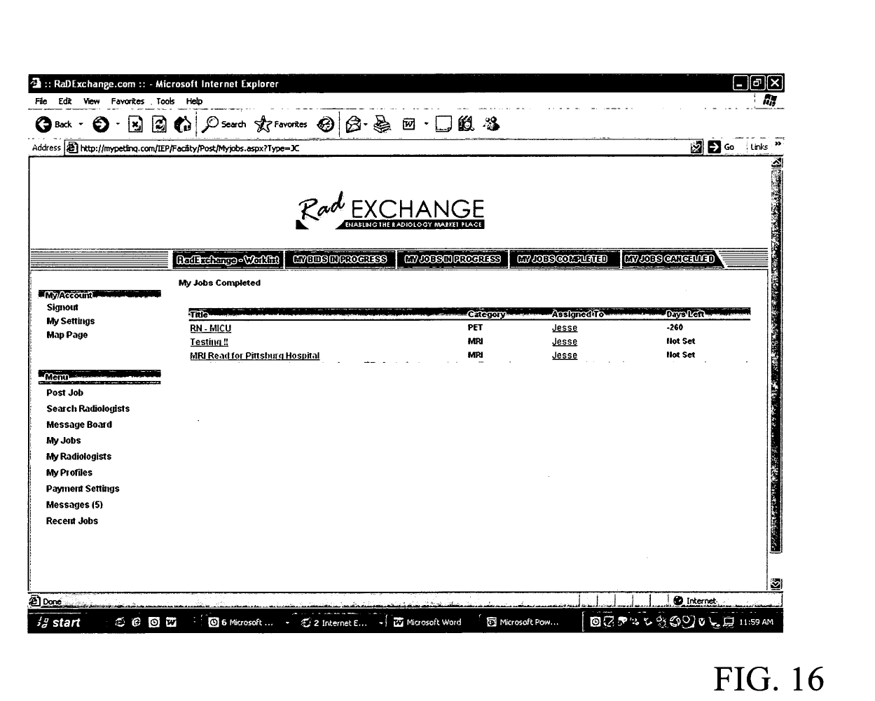

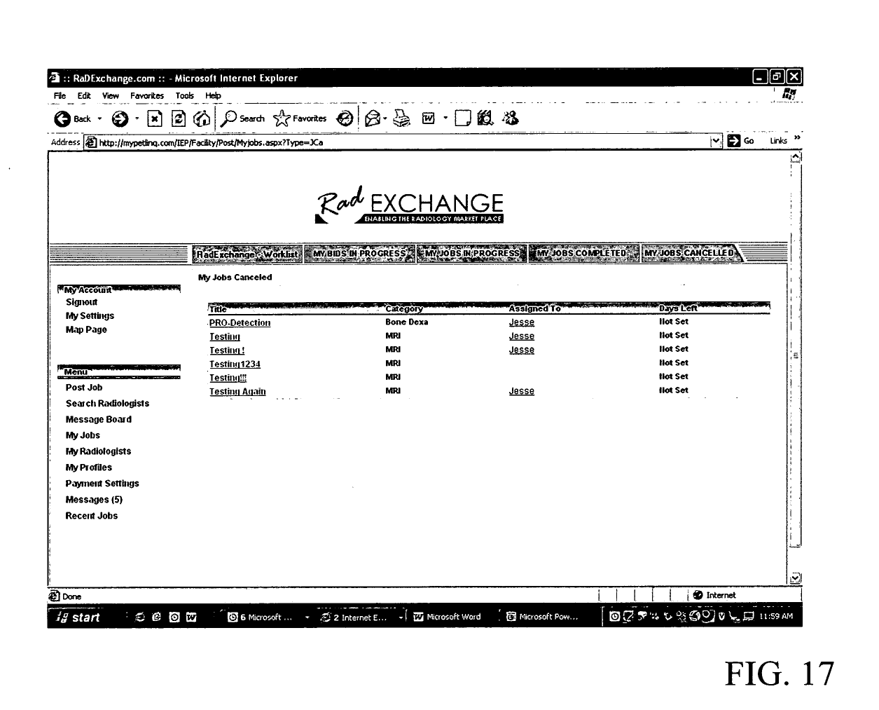

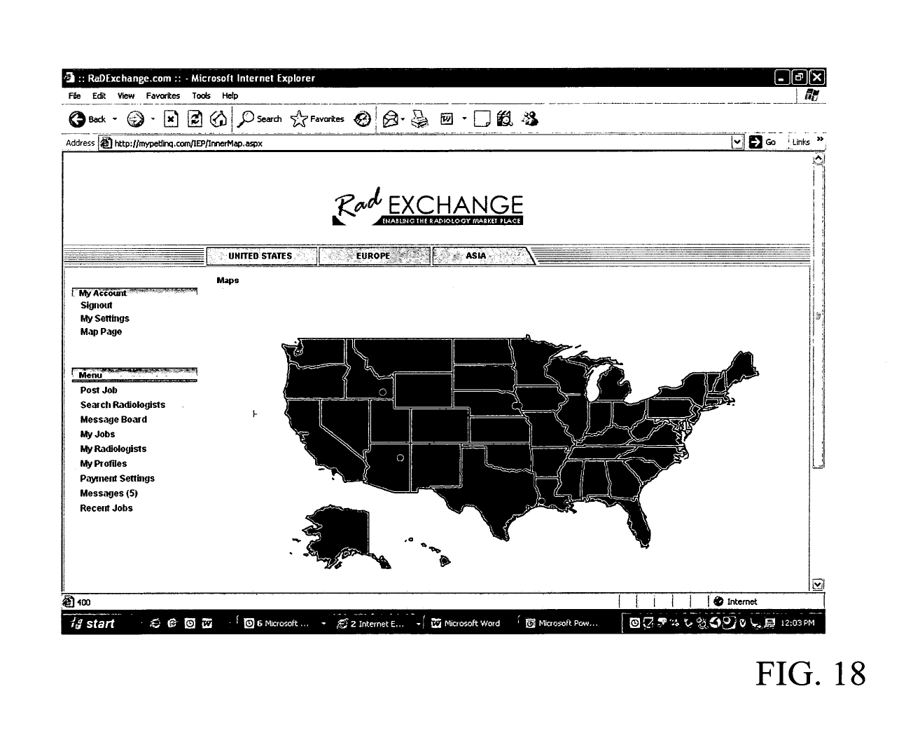

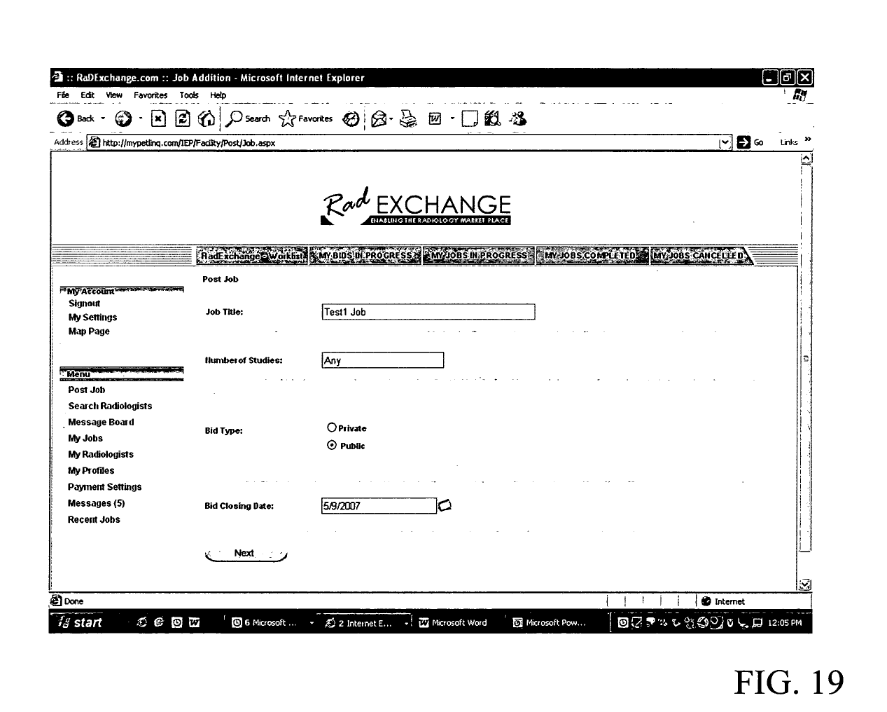

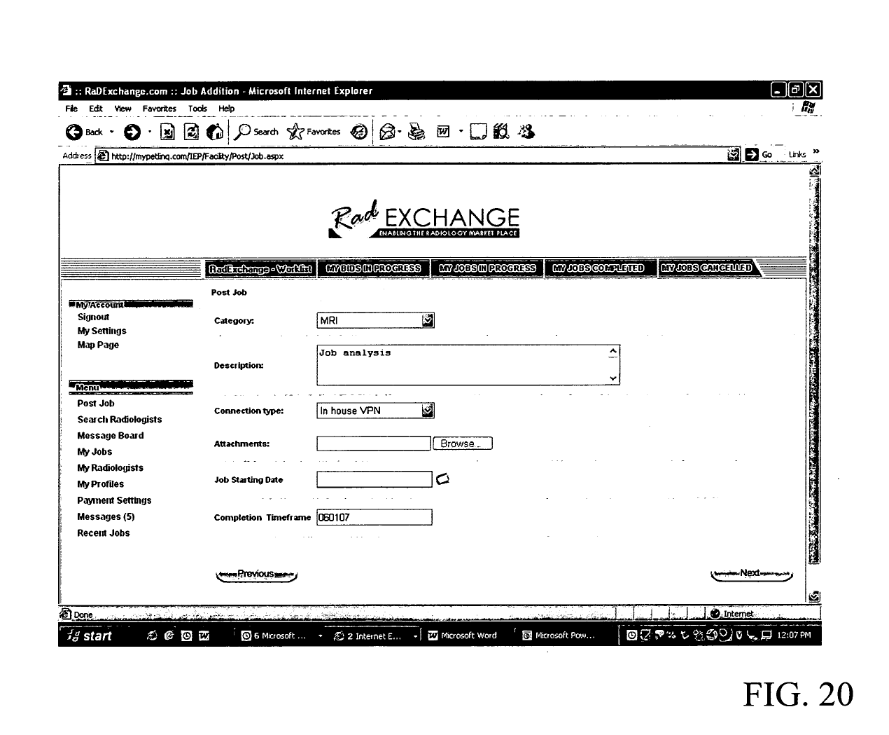

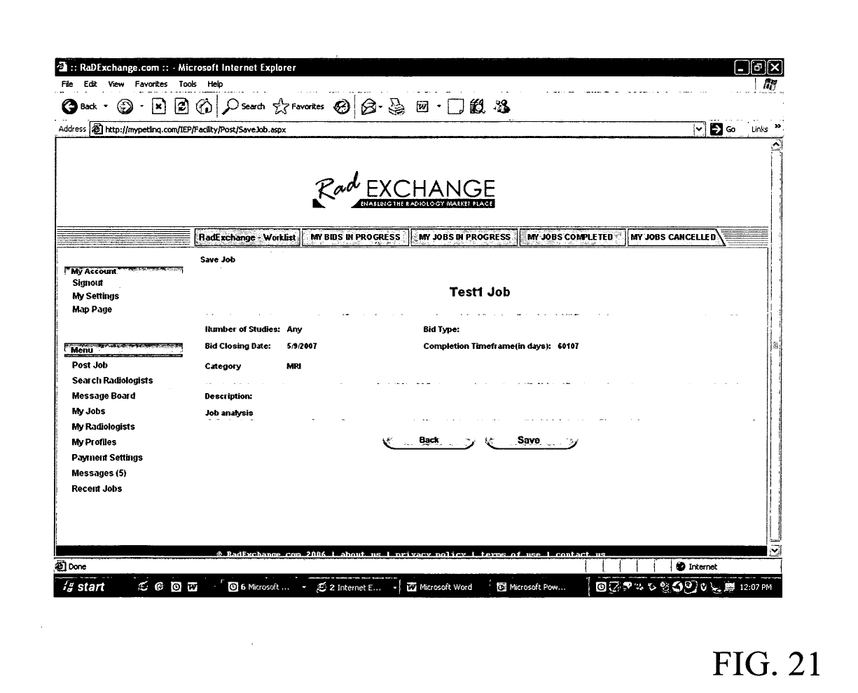

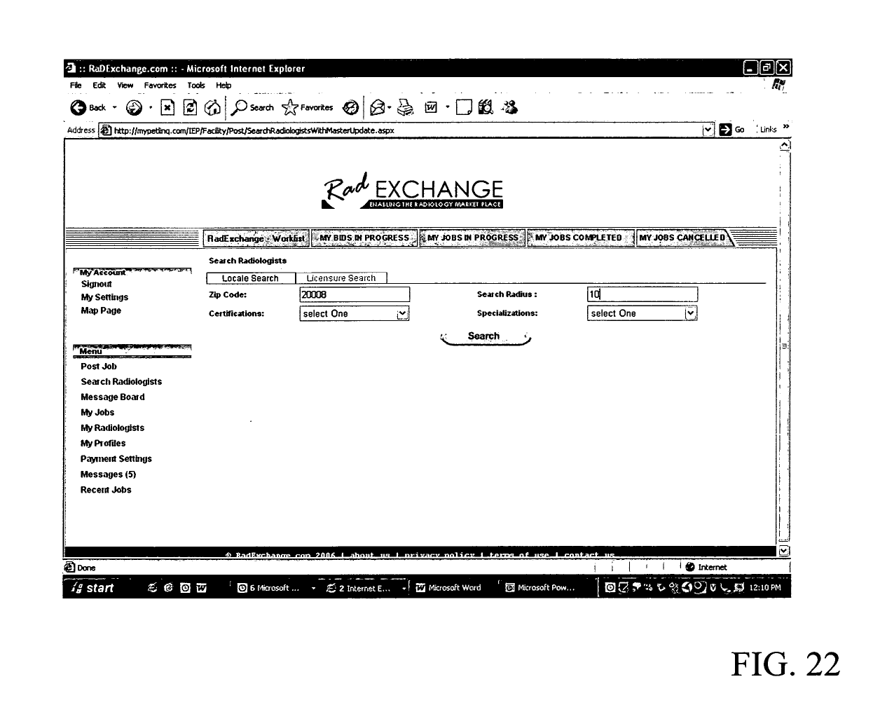

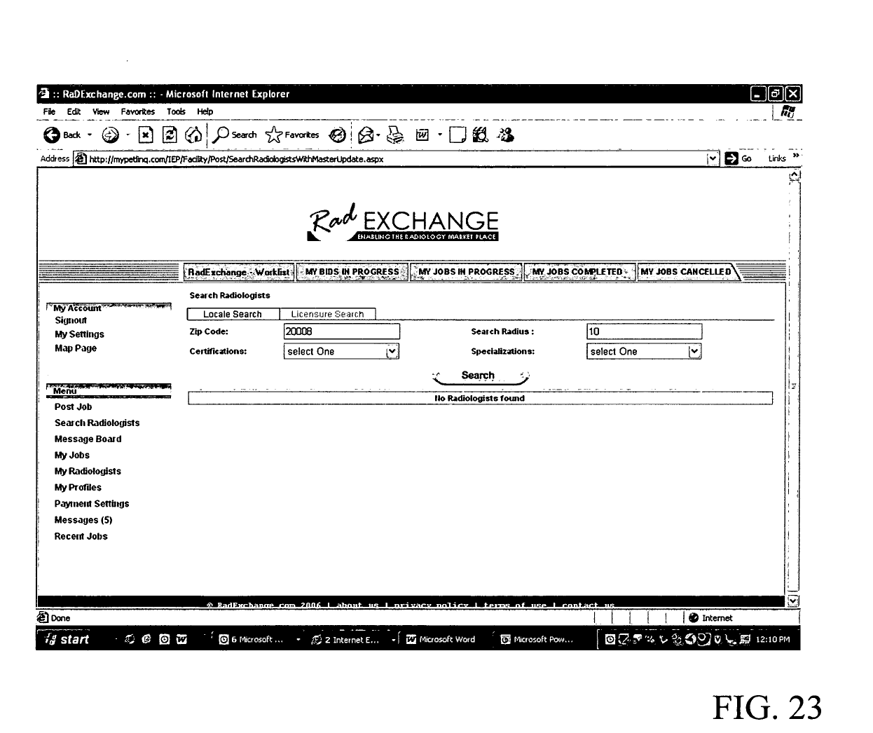

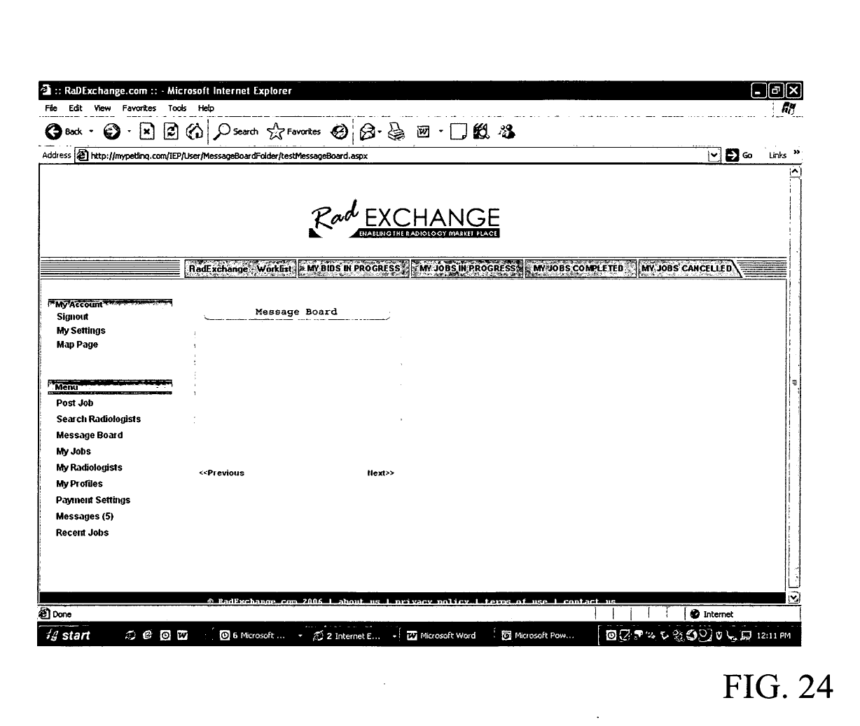

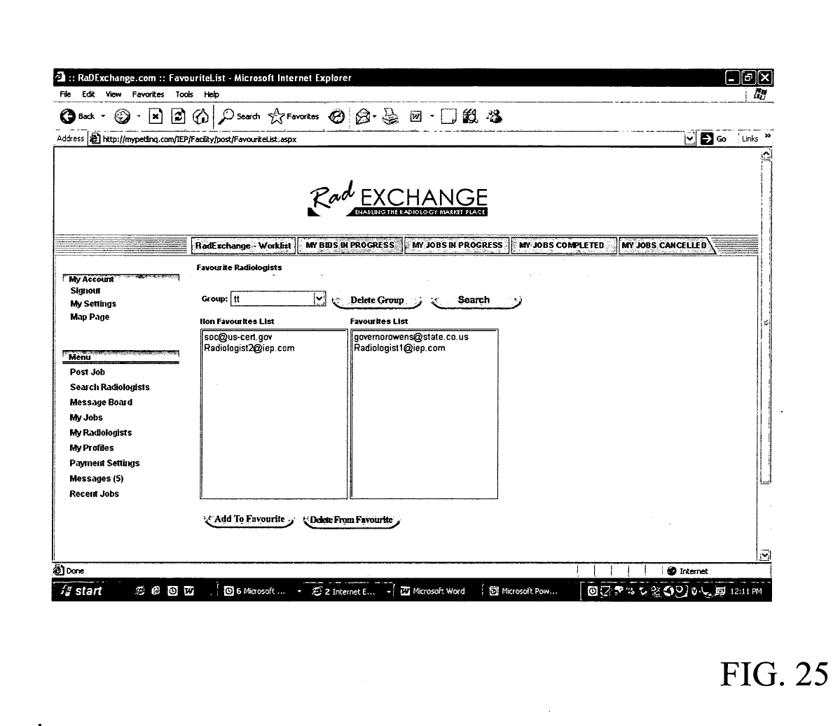

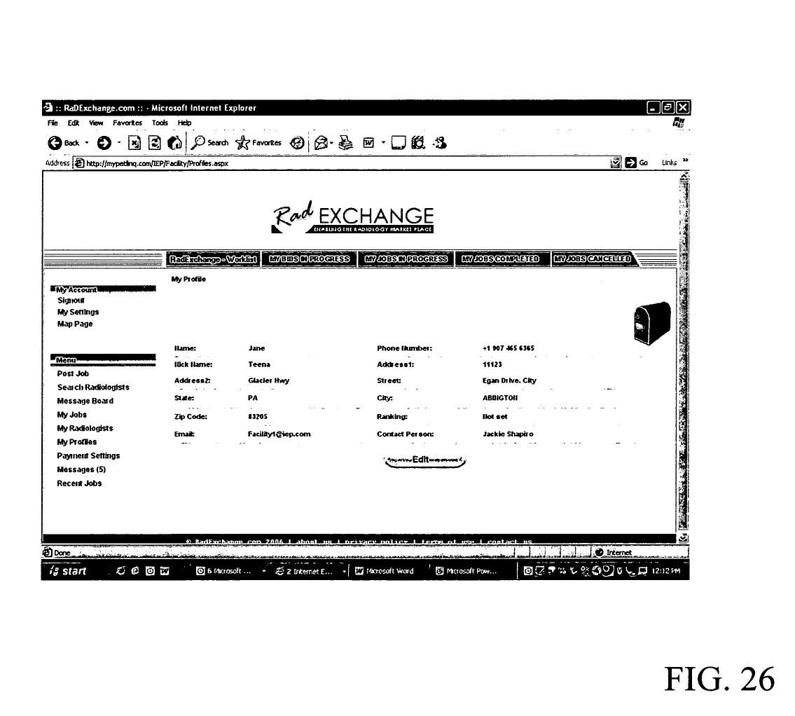

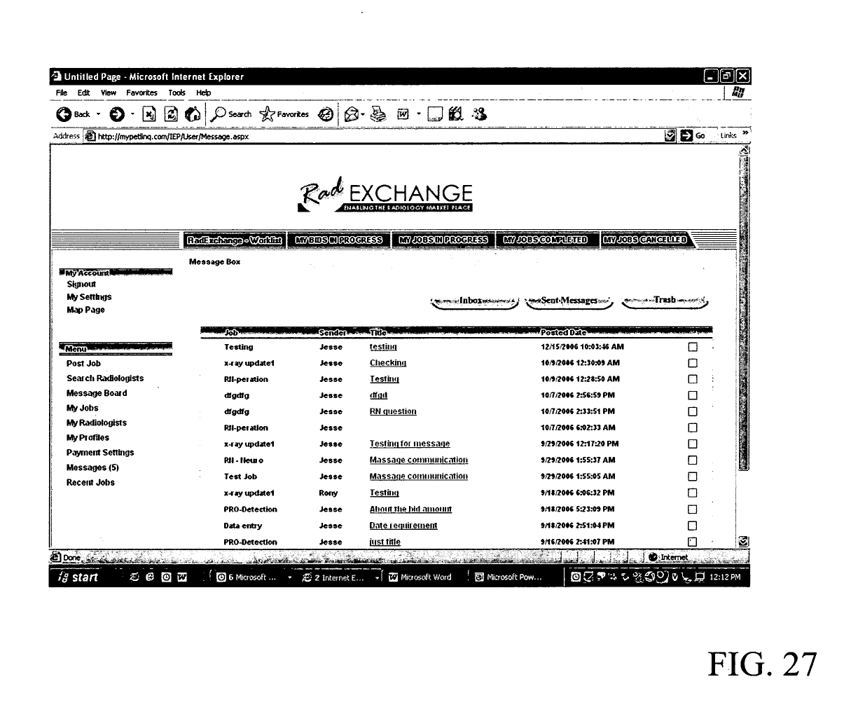

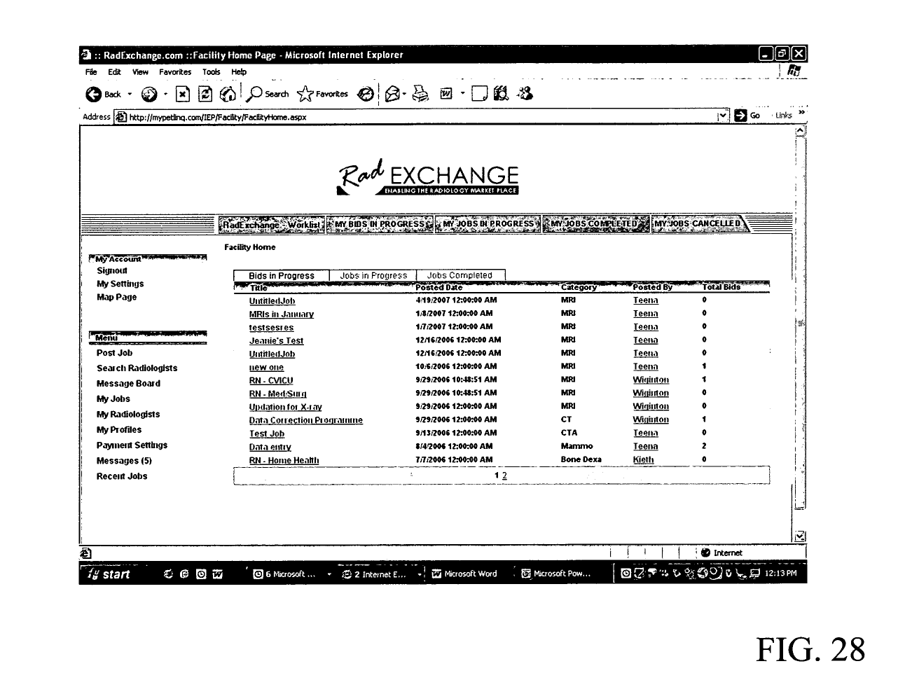

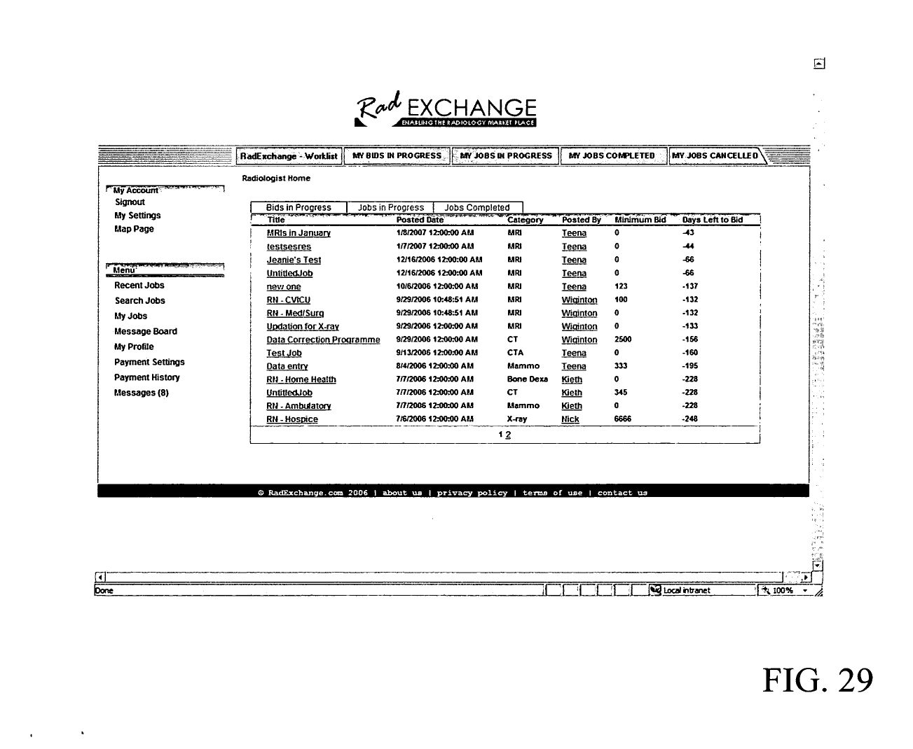

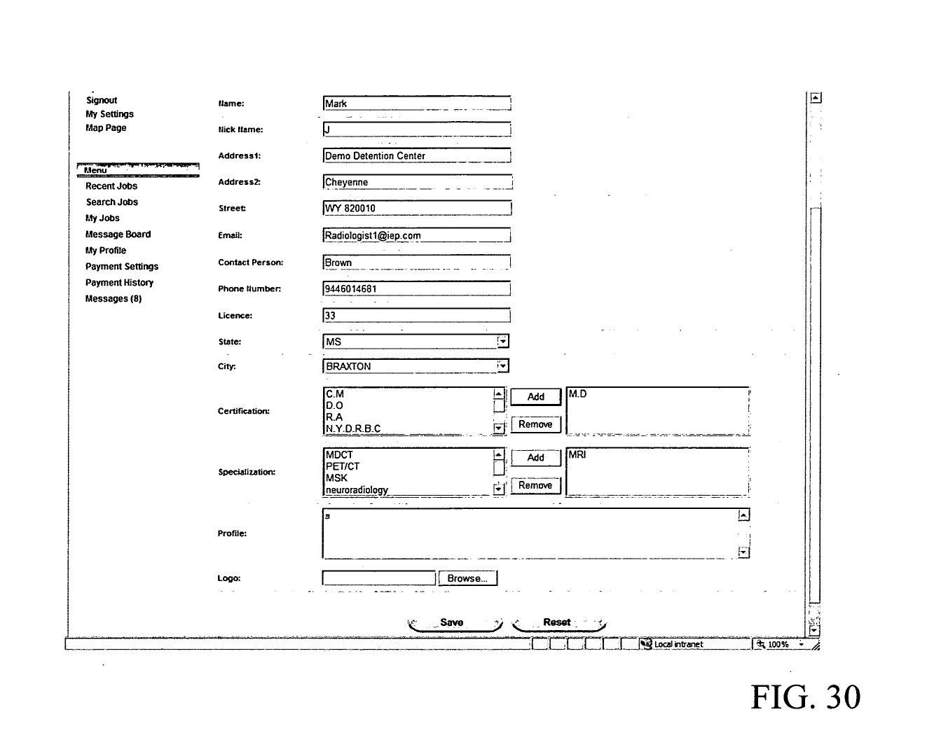

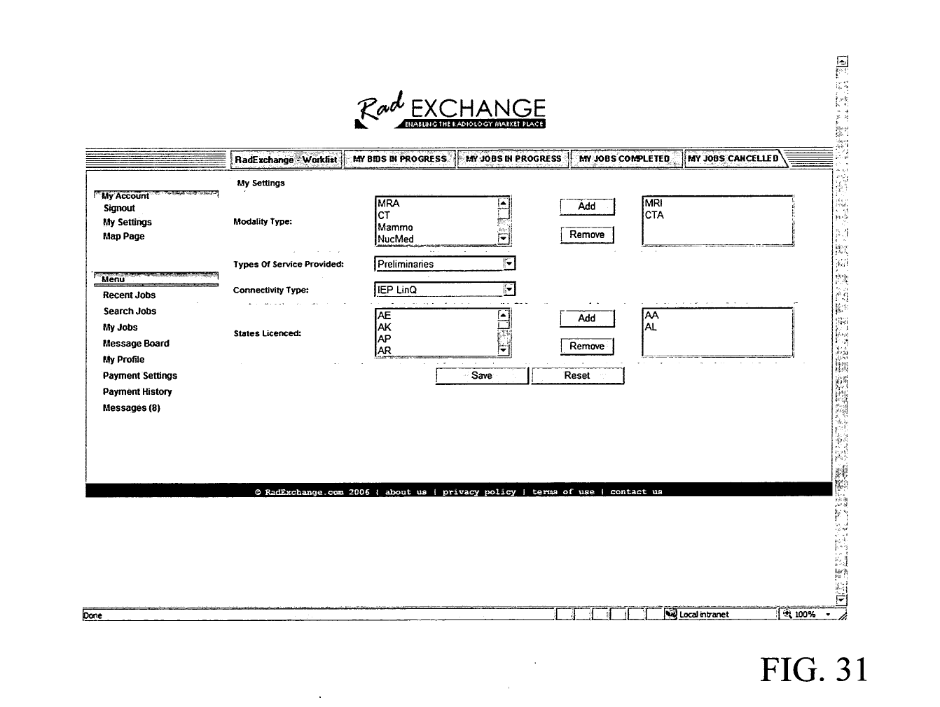

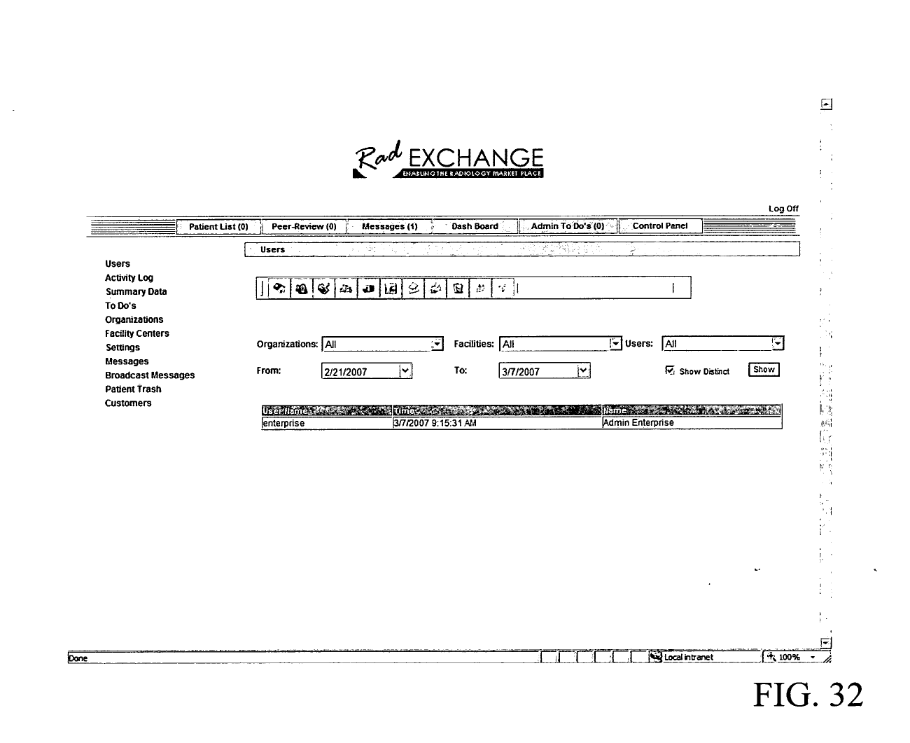

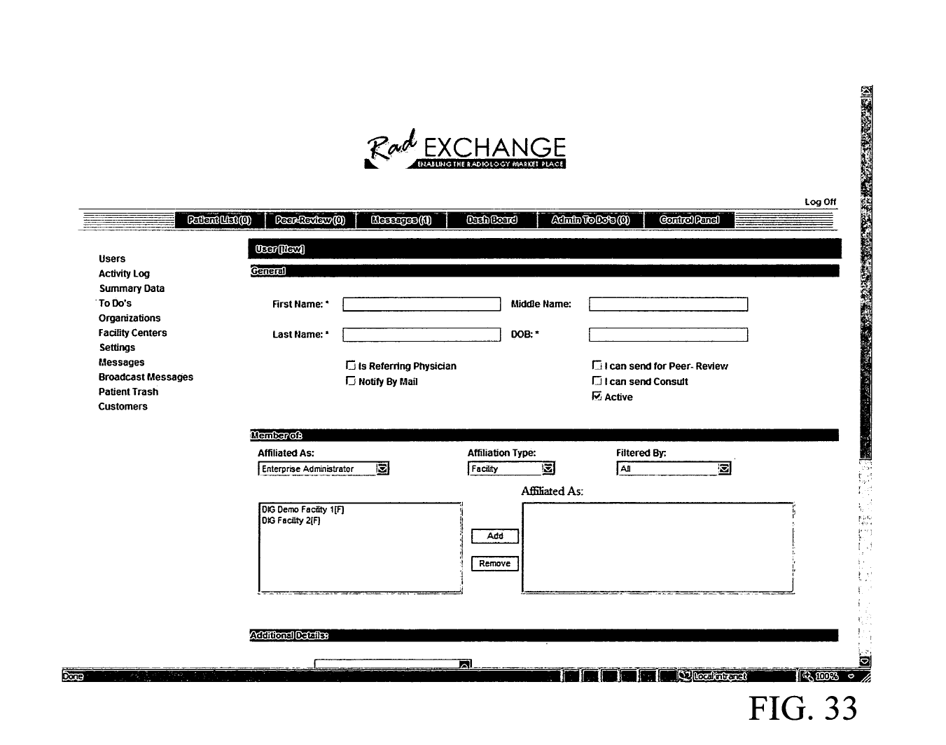

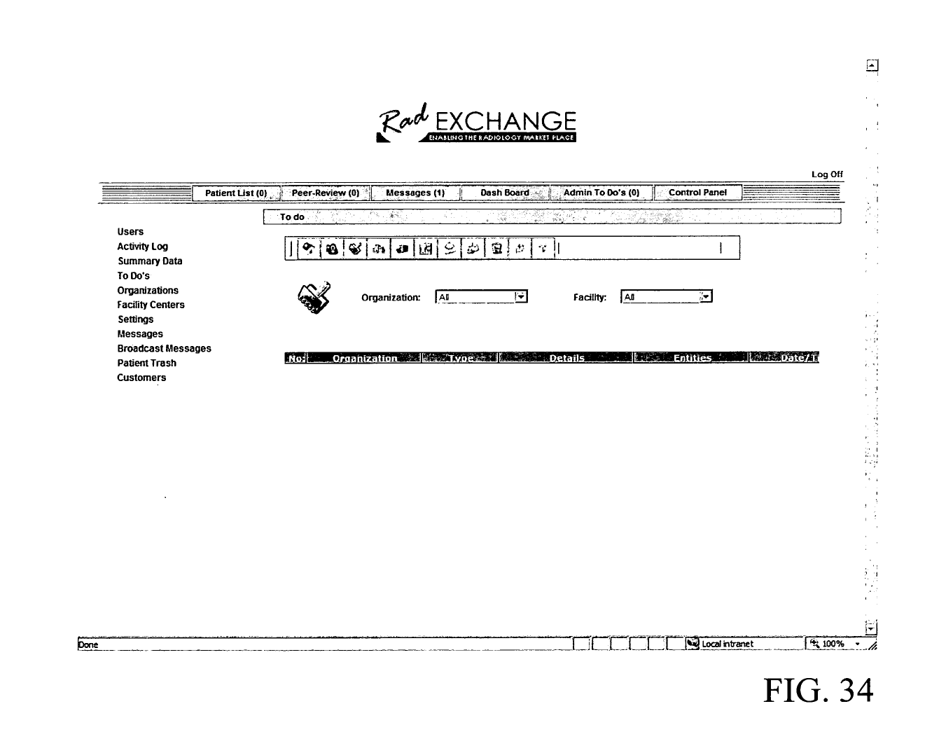

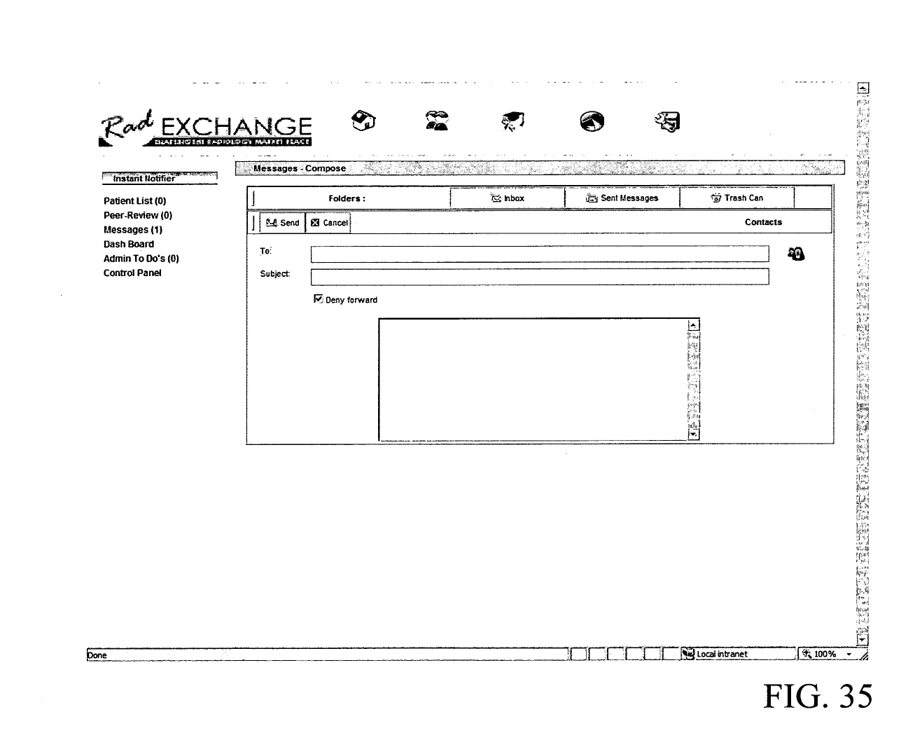

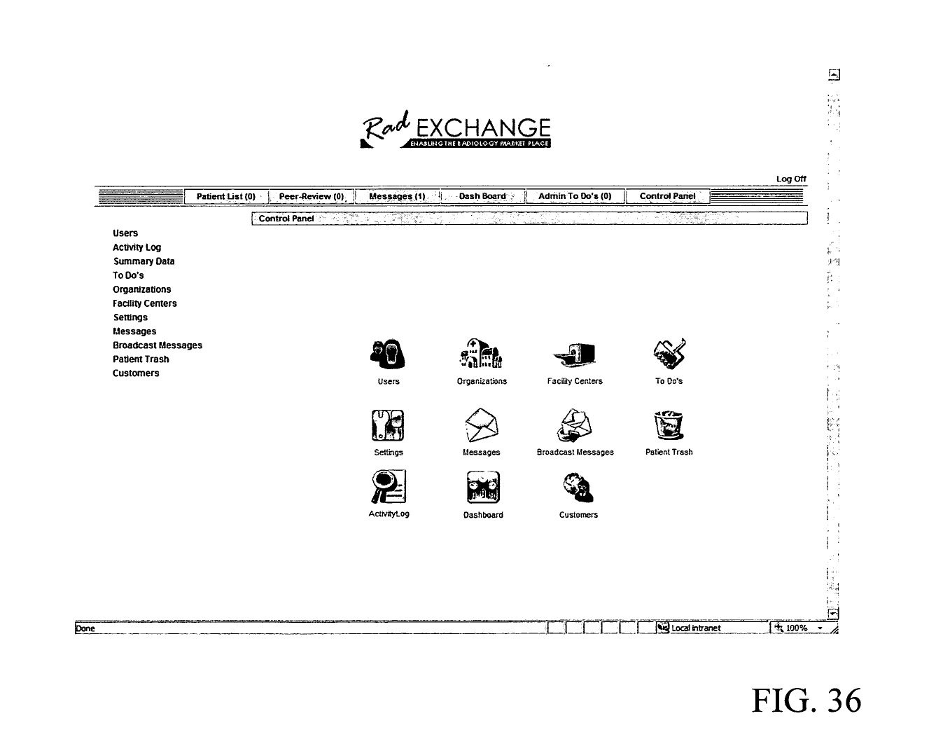

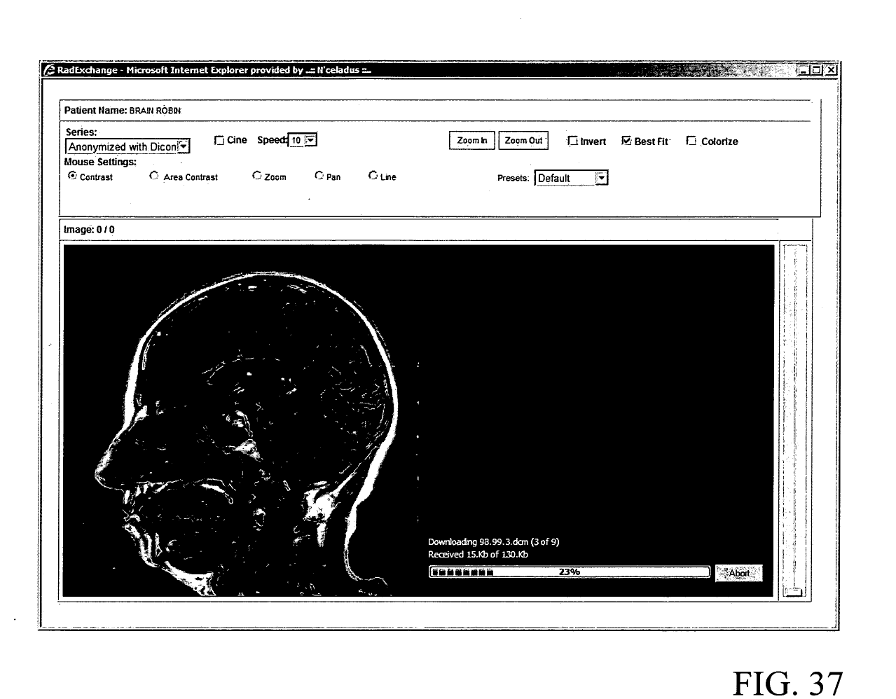

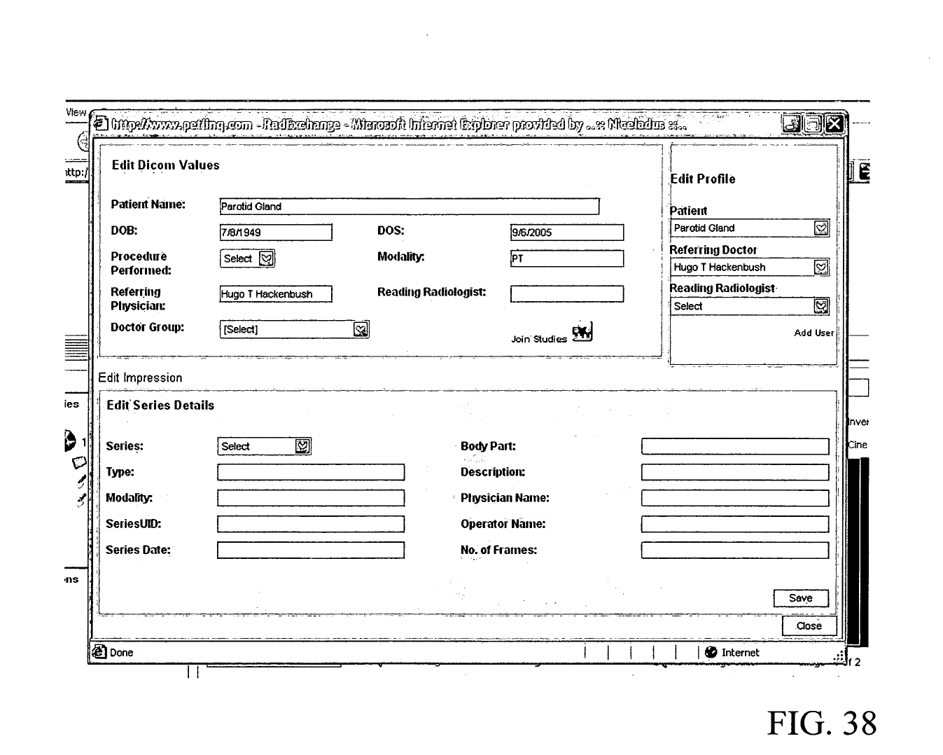

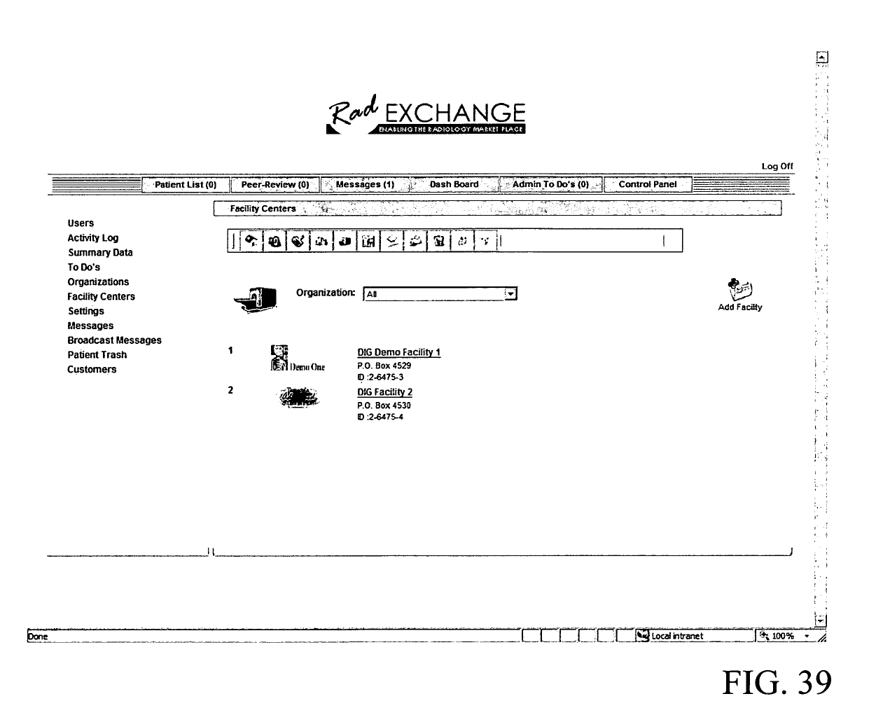

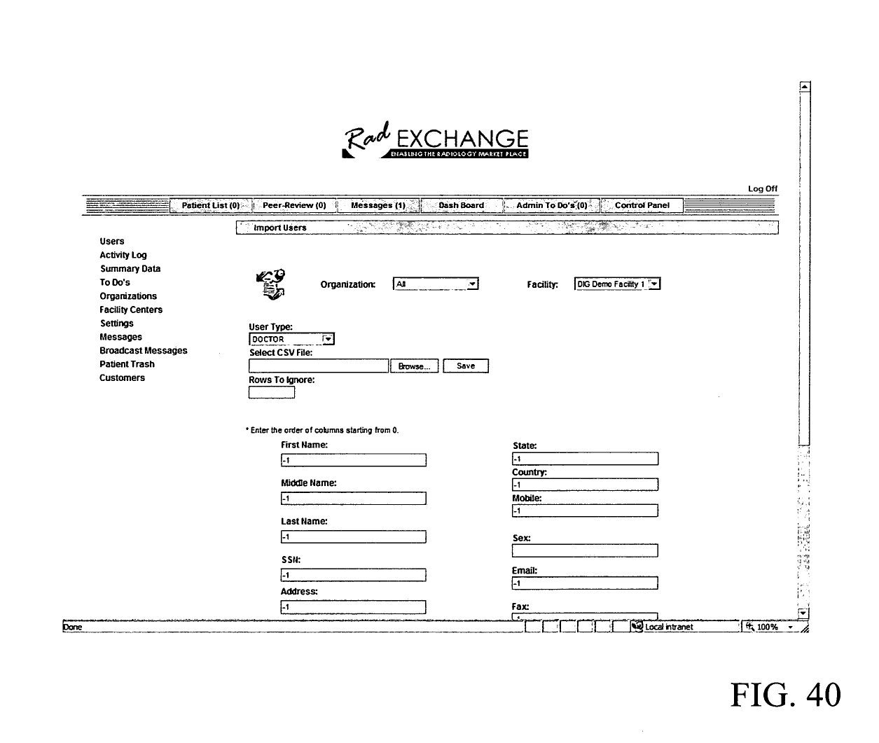

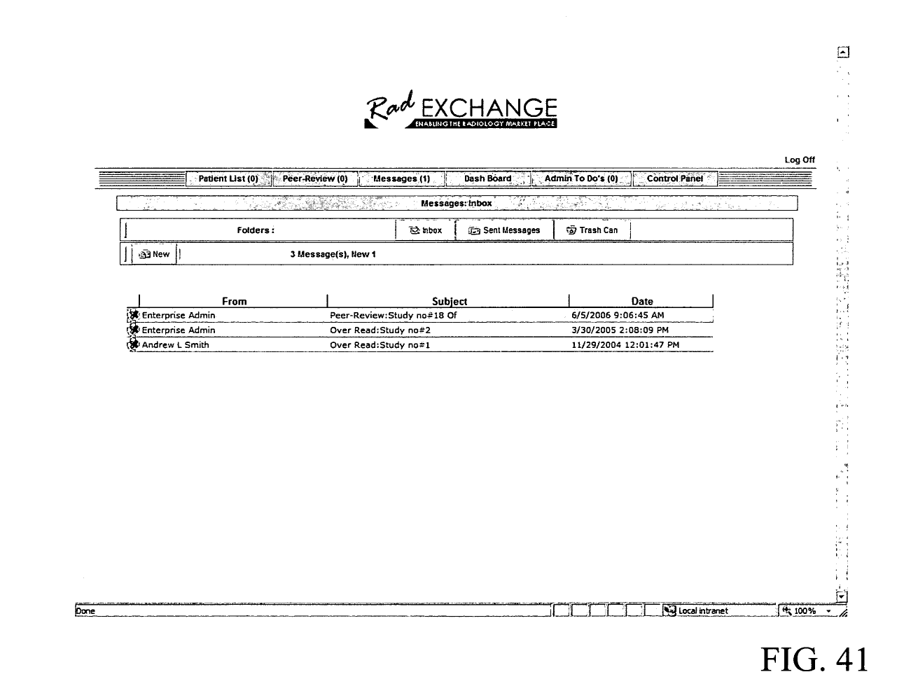

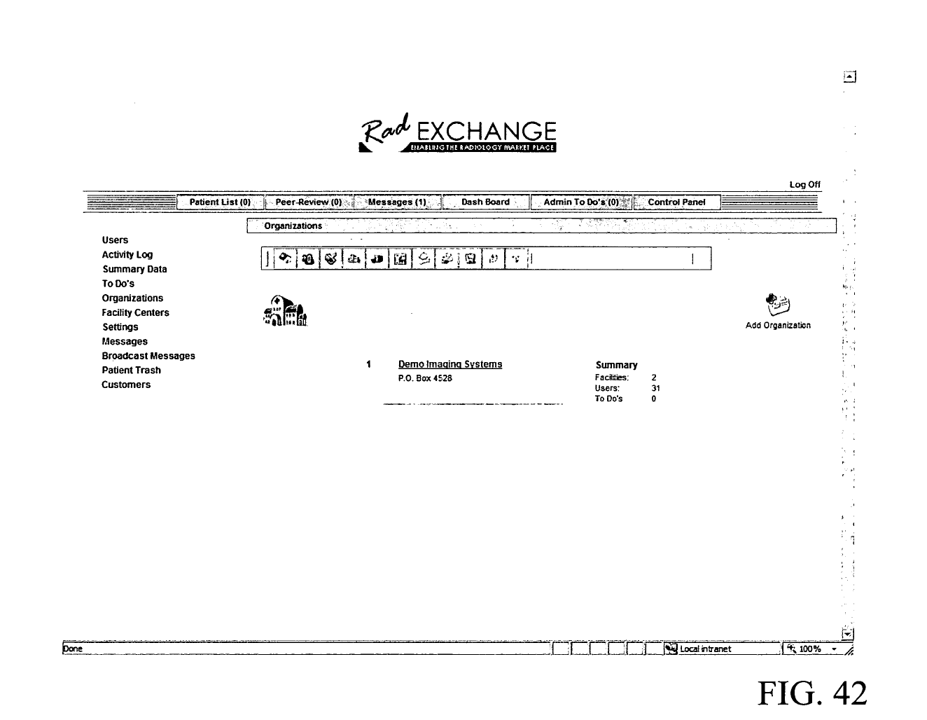

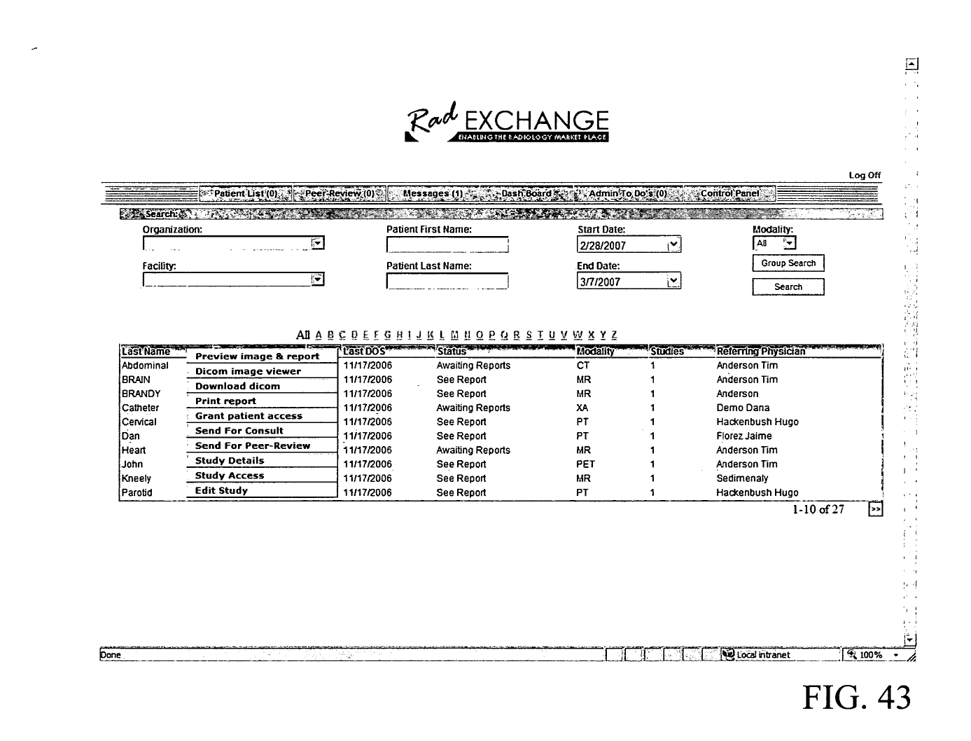

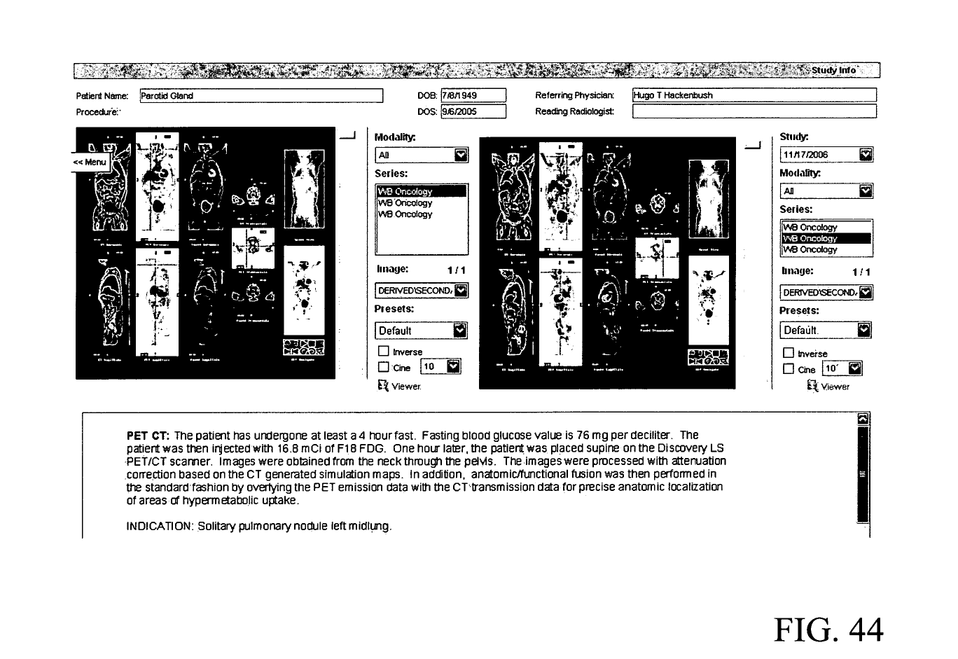

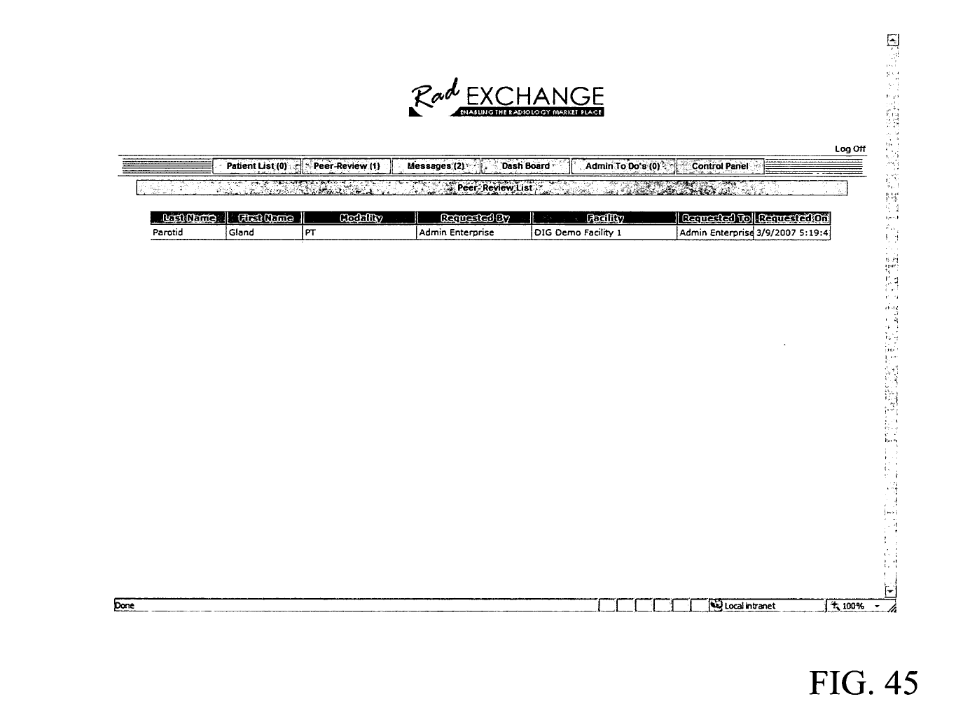

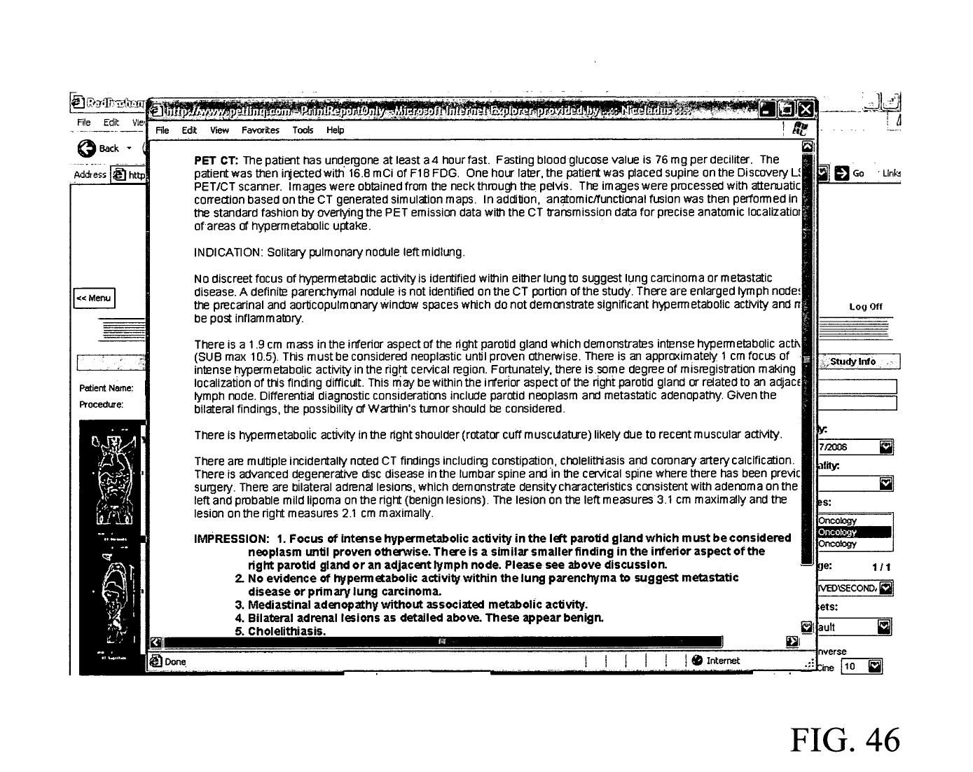

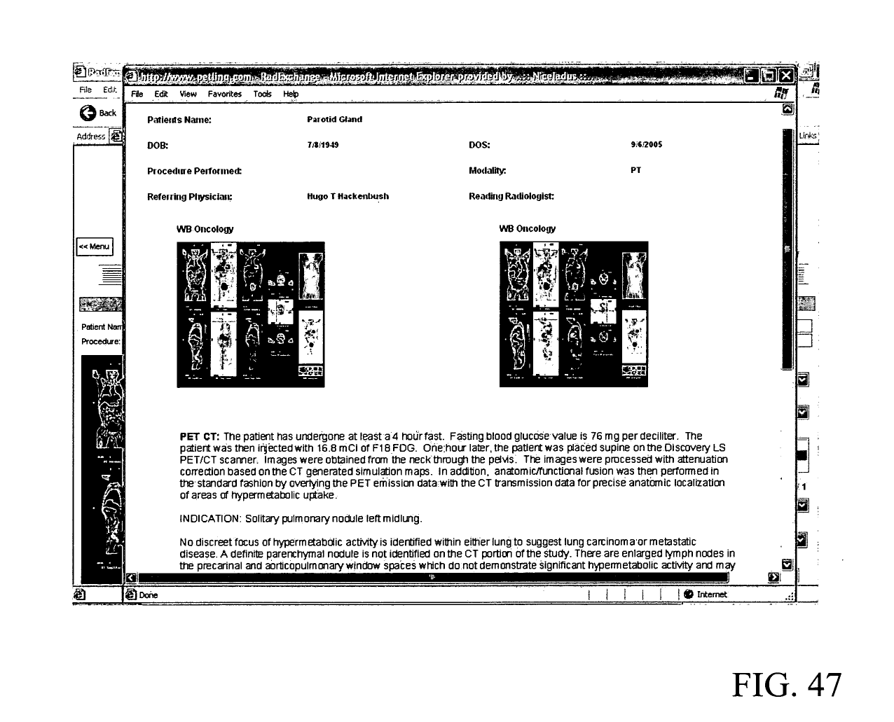

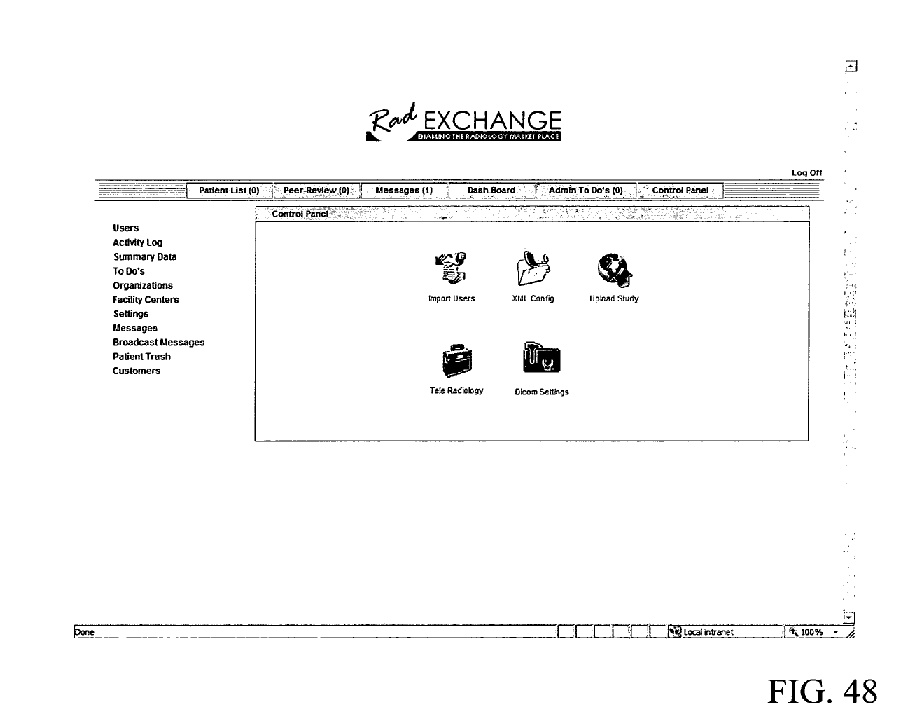

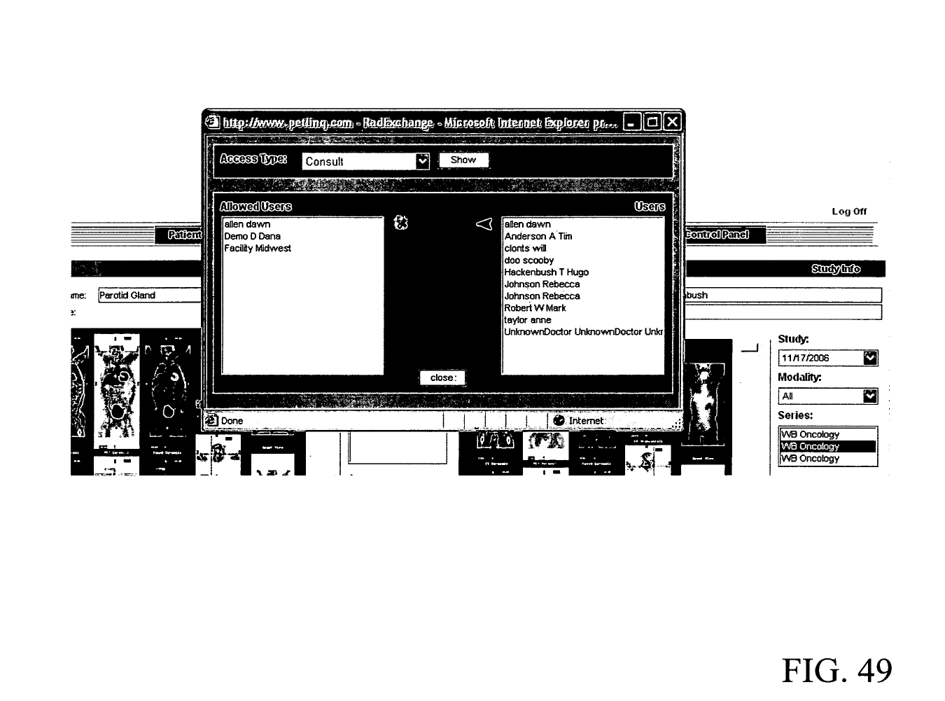

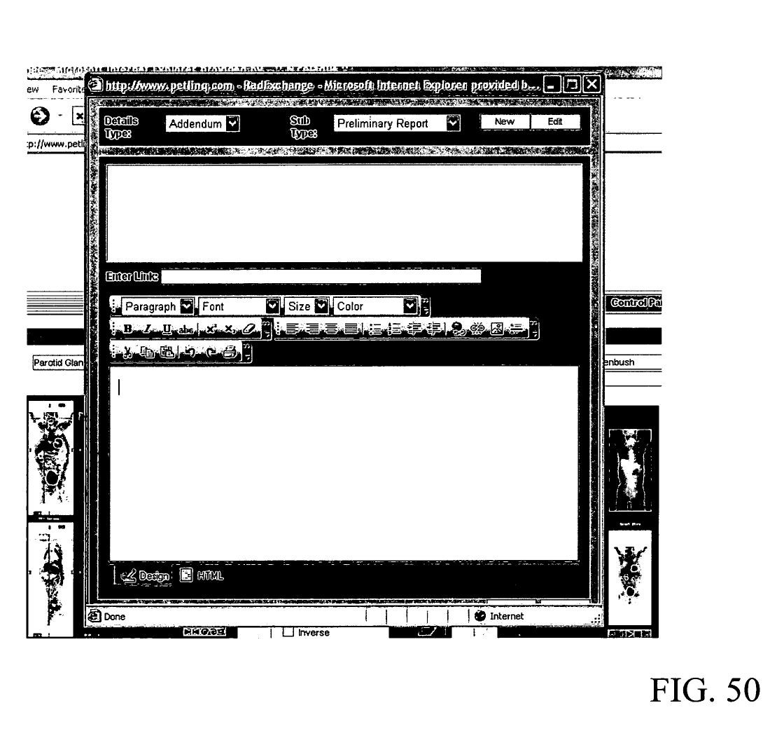

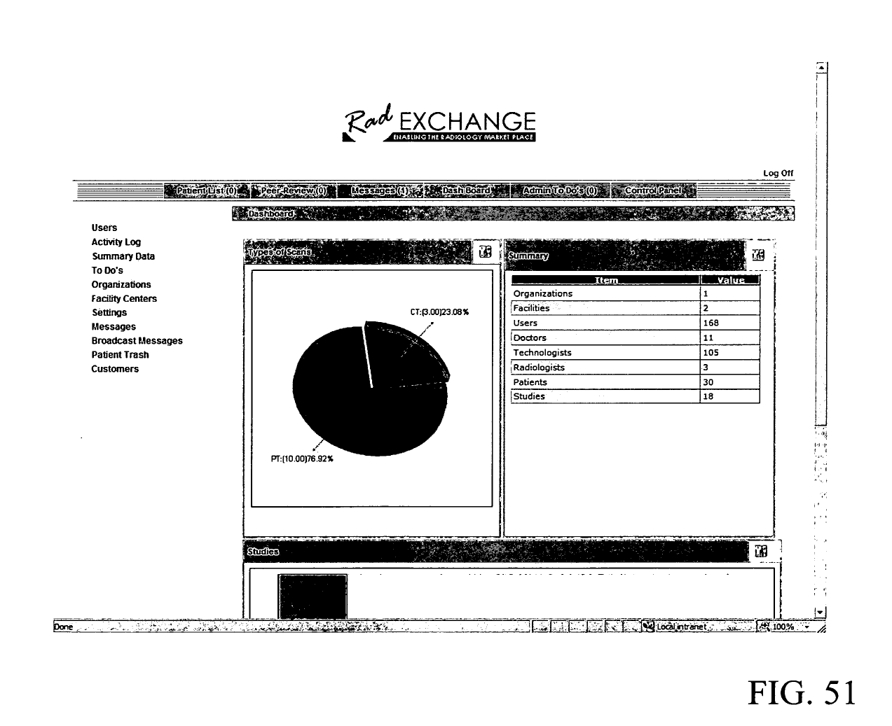

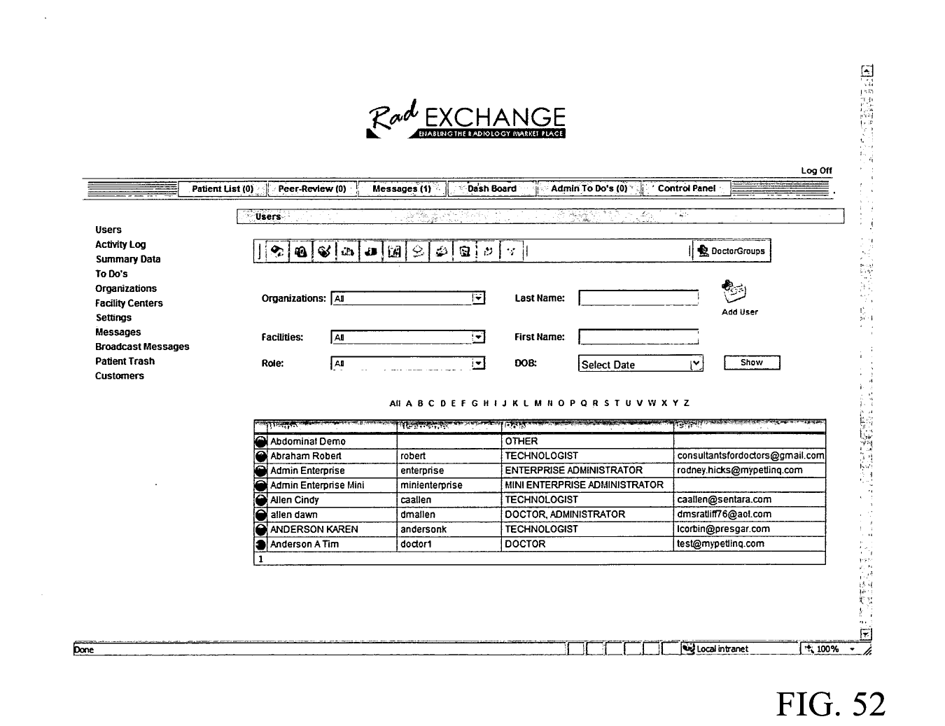

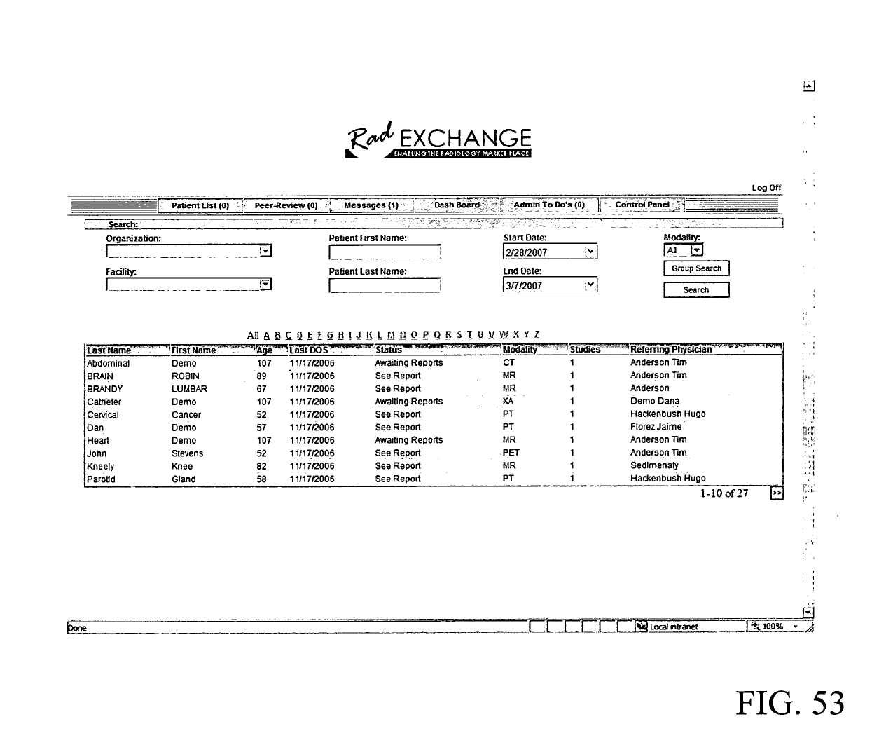

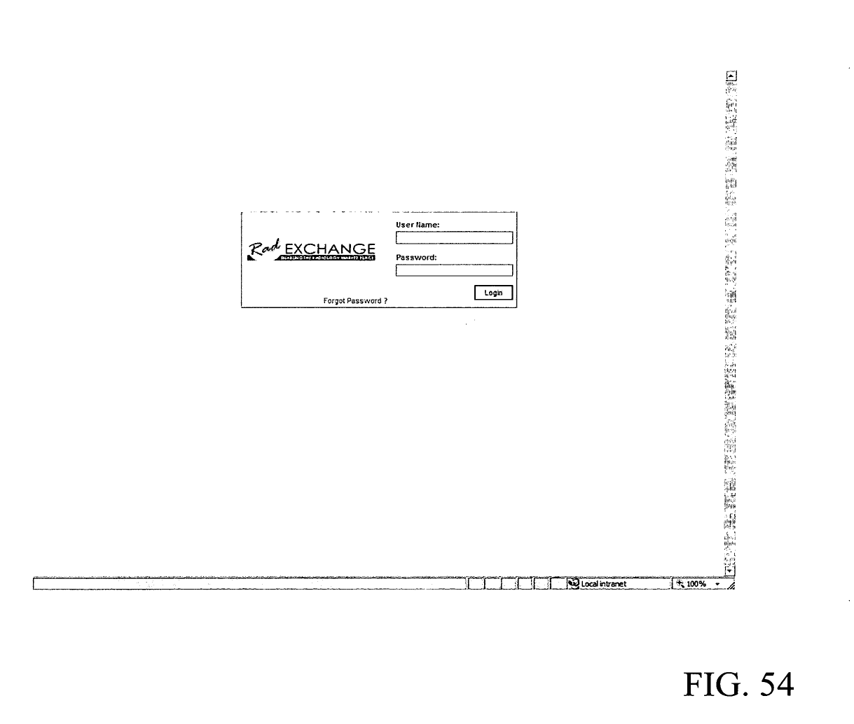

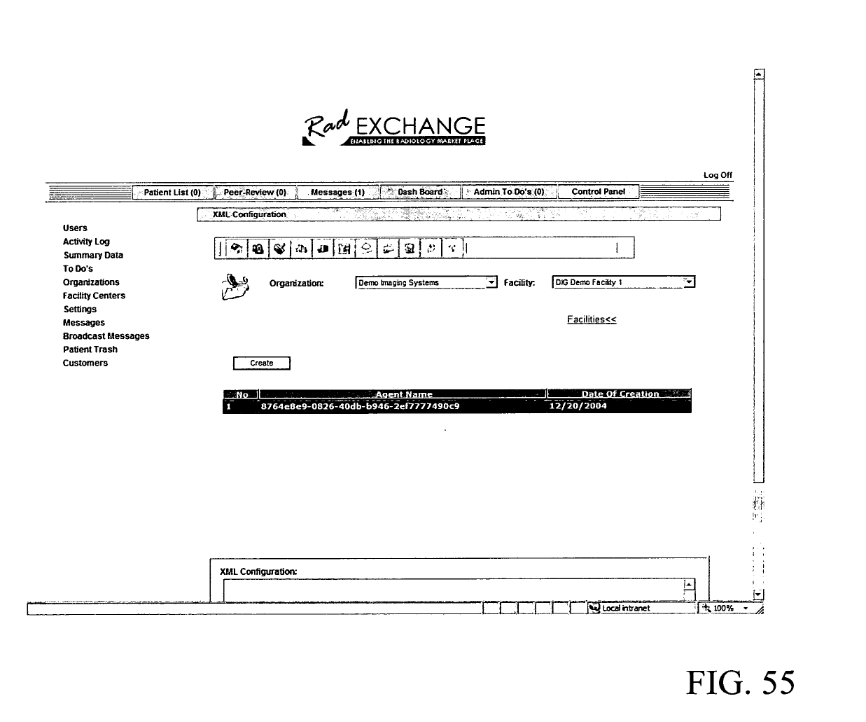

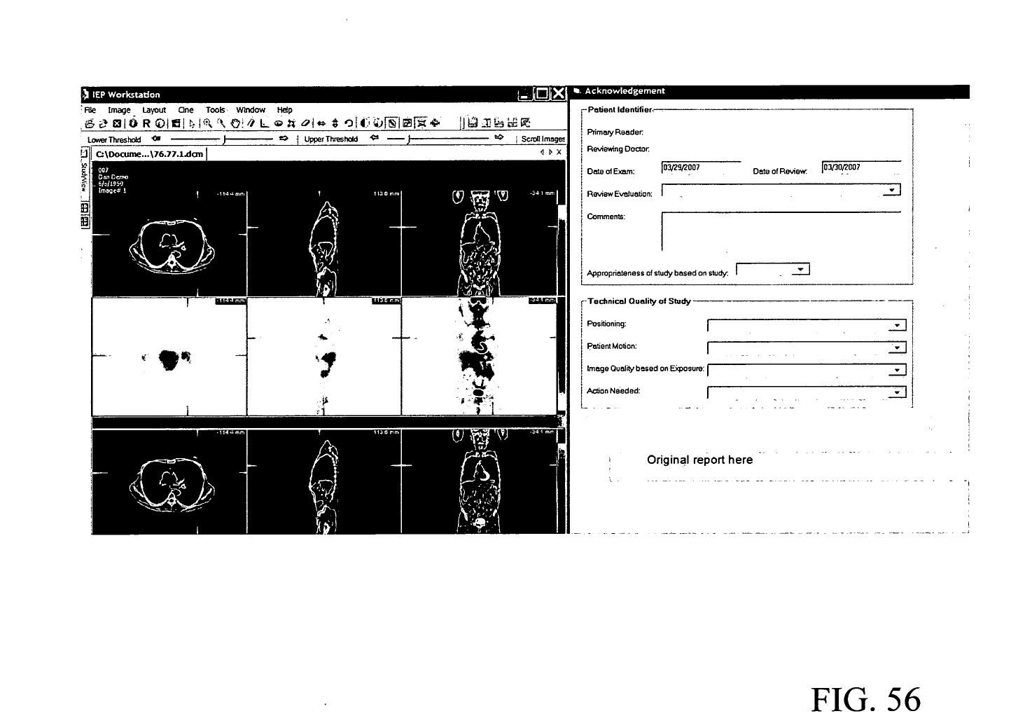

FIGS. 8-56 contain exemplary graphical user interface (GUI) screens for logging into and performing sample operations in an exemplary software system, in accordance with an embodiment of the present invention. In particular, for example, FIG. 56 illustrates how a reviewer to view the previously performed image analysis, the original report generated during that review, and peer review the image analysis. Thus, all the elements of the peer review are available on either a single screen or on multiple screens.

According to an example embodiment, the party posting images to be analyzed may also post various requirements for any bidder to consider in order to analyze the images. For example, the party posting the image to be analyzed may require that the images be analyzed before a certain date, or below a certain price, or meet any other requirement. Also, once the transaction is approved by the parties, the images may be provided to the image analyst either via a network, such as the Internet, by mail, or via a third party. For example, if the image to be analyzed is a pathology slide, then a third party may be selected to provide the analyst with the image.

Furthermore, while this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. An automated method for medical related data exchange and analysis, comprising:
facilitating transfer of medical related data;
receiving one or more bids from at least one medical related data analyst for performing an analysis of the medical related data;
providing a peer review for each of the at least one medical related data analyst; and
selecting a medical related data analyst on the basis of the one or more bids and each peer review.

2. The method of claim 1, wherein facilitating transfer of the medical related data comprises:
receiving the medical related data from an medical data owner and providing the medical related data on a server accessible to each of the at least one medical related data analyst.

3. The method of claim 1, wherein the peer review for each of the at least one medical related data analyst is performed by at least one peer and is stored in a database.

4. The method of claim 3, wherein providing the peer review comprises: providing selectable one or more stored peer reviews of the at least one medical related data analyst.

5. The method of claim 2, further comprising:
enabling a transaction between the medical data owner and the selected medical related data analyst, wherein the transaction is performed either via a server or directly between the medical data owner and the one or more medical related data analysts.

6. The method of claim 1, wherein the medical related data is provided to the selected medical related data analyst via a third party.

7. The method of claim 1, wherein the medical related data is selected from a group consisting of a radiological image, imaging related diagnostic data set, digitized pathology data, including gross, microscopic and laboratory test data, a digitized image of a pathologic specimen, and any medical diagnostic data set.

8. The method of claim 2, wherein the medical data owner provides parameters for analyzing the medical related data.

9. The method of claim 8, wherein the parameters comprise at least one selected from a group consisting of time schedule, price, and specific medical related data analyst.

10. The method of claim 2, wherein the medical data owner contacts a preferred medical related data analyst directly.

11. The method of claim 1, wherein the peer review for each of the at least one medical related data analyst is stored in a database accessible to the medical data owner.

12. The method of claim 11, wherein the peer review for each of the at least one medical related data analyst comprises at least one selected from a group consisting of name, address, specialty, and fees typically charged.

13. The method of claim 3, wherein each peer review includes an assessment of a medical related data analysis performed by one of the at least one medical related data analyst.

14. The method of claim 1, wherein each peer review comprises a combined assessment of one or more peers that have reviewed the at least one medical related data analyst.

15. The method of claim 1, further comprising:
determining whether each peer review is consistent with any previous peer reviews of the at least one medical related data analyst.

16. The method of claim 14, further comprising:
comparing the combined assessment to a threshold assessment.

17. The method of claim 16, further comprising:
if the combined assessment is below the threshold assessment, designating the at least one medical related data analyst as underperforming.

18. The method of claim 1, wherein each of the at least one medical related data analyst provides an opinion of the peer review.

19. The method of claim 18, wherein each of the at least one medical related data analyst provides the opinion via a server accessible to other medical related data analysts and to medical data owners.

20. The method of claim 16, wherein, when the combined assessment is above the threshold assessment, the at least one medical related data analyst is designated as performing well.

21. The method of claim 20, wherein, if the medical related data analyst is performing well, the medical related data analyst is recommended for further medical related data analyses.

22. A system for medical related data analysis peer review, comprising:
means for facilitating transfer a medical related data;
means for receiving one or more bids from at least one medical related data analyst for performing an analysis of the medical related data;
means for consulting a peer review for each of the at least one medical related data analyst; and
means for selecting a medical related data analyst on the basis of the one or more bids and each peer review.

23. The system of claim 22, comprising means for storing information about a plurality of medical related data analysts.

24. The system of claim 23, wherein the stored information comprises at least one selected from a group consisting of name, address, specialty, and fees typically charged.

25. A system for medical related data analysis peer review, the system comprising:
a processor;
a user interface functioning via the processor; and
a repository accessible by the processor; wherein
a medical related data is hosted on a server;
one or more bids from are received from at least one medical related data analyst for performing an analysis of the medical related data;
a peer review of each of the at least one medical related data analyst is provided; and
a medical related data analyst is selected on the basis of the one or more bids and each peer review.

26. A computer program product comprising a computer usable medium having control logic stored therein for causing a computer to peer review medical related data analysis, the control logic comprising:
first computer readable program code means for hosting medical related data;
second computer readable program code means for receiving one or more bids from at least one medical related data analyst for performing an analysis of the medical related data;
third computer readable program code means for providing a peer review for each of the at least one medical related data analyst; and
fourth computer readable program code means for selecting a medical related data analyst on the basis of the one or more bids and each peer review.

27. The method of claim 7, wherein the digitized image of the pathologic specimen is selected from a group consisting of gross laboratory test data, microscopic laboratory test data, and laboratory test data.
